(19) United States
(12) Patent Application Publication
(10) Pub. No.: US 2026/0202697 A1
(43) Pub. Date: Jul. 16, 2026

(54) THIN FILM LITHIUM-CONTAINING COMPACT ELECTRO-OPTIC DEVICES

(71) Applicant: HyperLight Corporation, Cambridge, MA (US)

(72) Inventors: Mian Zhang, Cambridge, MA (US); Sean P. Anderson, Macungie, PA (US); Lingfei Zhao, Cambridge, MA (US); Christian Reimer, Wellesley, MA (US); Derek Matthew Kita, Somerville, MA (US); Dominick Scordo, Leonardo, NJ (US); Jeffrey Cole Holzgrafe, Lexington, MA (US); Fan Ye, Lincoln, MA (US)

(21) Appl. No.: 19/446,800

(22) Filed: Jan. 12, 2026

Related U.S. Application Data
(60) Provisional application No. 63/744,684, filed on Jan. 13, 2025.
(60) Provisional application No. 63/744,681, filed on Jan. 13, 2025.

(51) Int. Cl. G02F 1/035

(52) U.S. Cl. CPC G02F 1/035; G02F 2201/063; G02F 2201/066; G02F 2201/127; G02F 2201/50; G02F 2202/20

(57) ABSTRACT

An electro-optic device is described. The electro-optic device includes multiple optical modulators corresponding to multiple channels. Each optical modulator includes at least one thin film lithium-containing (TFLC) material. The optical modulators have a pitch of not more than two hundred micrometers.

### CROSS REFERENCE TO OTHER APPLICATIONS

This application claims priority to U.S. Provisional Patent Application No. 63/744,681 entitled THIN FILM LITHIUM-CONTAINING ELECTRO-OPTIC DEVICES HAVING COMPACT TAPERS filed January 13, 2025 and U.S. Provisional Patent Application No. 63/744,684 entitled THIN FILM LITHIUM-CONTAINING COMPACT ELECTRO-OPTIC MODULATOR filed January 13, 2025, both of which are incorporated herein by reference for all purposes.

### BACKGROUND OF THE INVENTION

Lithium-containing (LC) electro-optic materials, such as lithium niobate (LN) and/or lithium tantalate (LT), may be desired to be used in optical devices such as photonics integrated circuits (PICs). Thin film lithium-containing (TFLC) materials may include materials such as thin film LN (TFLN) and/or thin film LT (TFLT). TFLC PICs may support high data rates and low losses. These characteristics are desirable in applications such as data communication and/or telecommunication. Such TFLC photonic integrated circuits (TFLC PICs) are also desired to be integrated with other components. For example, a TFLC PIC may be desired to be used in conjunction with a silicon-based driver circuit, a silicon-based receiver, processing unit(s), and/or another IC.

Optical interfaces for PICs, particularly TFLC PICs, pose major challenges. For example, the use of TFLC PICs with other PICs may present trade-offs in electro-optic bandwidth. Moreover, the ability to couple data signals into or out of PICs may be limited by the width of the PIC. Components including PICs and other ICs are desired to be relatively tightly packed to conserve space on a circuit board or other substrate. Thus, a compact size and a corresponding high bandwidth per millimeter of PIC width and/or a high bandwidth per optical fiber coupling to the PIC are desirable for a high bandwidth communication. However, PICs including components such as optical modulators may have limitations in characteristics such as size (e.g., width and length), V-pi-L and electro-optic bandwidth. These limitations may make TFLC PICs unsuitable for such uses. Accordingly, what is needed is an improved method for utilizing TFLC PICs, particularly for applications such as data and other communications.

### BRIEF DESCRIPTION OF THE DRAWINGS

Various embodiments of the invention are disclosed in the following detailed description and the accompanying drawings.

FIG. 1 is a block diagram of an embodiment of a thin film lithium-containing optical device.

FIGS. 2A-2B depict an embodiment of a portion of a thin film lithium-containing optical device.

FIGS. 3A-3C depict an embodiment of a portion of a compact thin film lithium-containing optical device.

FIG. 4 depicts an embodiment of a portion of a compact thin film lithium-containing optical device.

FIG. 5 depicts a plan view of an embodiment of a portion of a compact thin film lithium-containing optical device.

FIG. 6 depicts a plan view of an embodiment of a portion of a compact thin film lithium-containing optical device.

FIG. 7 depicts a plan view of an embodiment of a portion of a compact thin film lithium-containing optical device.

FIG. 8 depicts a plan view of an embodiment of a portion of a compact thin film lithium-containing optical device.

FIG. 9 depicts a plan view of an embodiment of a portion of a compact thin film lithium-containing optical device.

FIG. 10 depicts a plan view of an embodiment of a portion of a compact thin film lithium-containing optical device.

FIGS. 11A-11C depict embodiments of portions of compact thin film lithium-containing optical devices.

FIG. 12 depicts a cross-sectional view of an embodiment of a portion of a compact thin film lithium-containing optical device.

FIG. 13 depicts a cross-sectional view of an embodiment of a portion of a compact thin film lithium-containing optical device.

FIG. 14 depicts a cross-sectional view of an embodiment of a portion of a compact thin film lithium-containing optical device.

FIG. 15 depicts a cross-sectional view of an embodiment of a portion of a compact thin film lithium-containing optical device.

FIGS. 16A-16C depict embodiments of portions of a compact thin film lithium-containing optical device.

FIGS. 17A-17B depict embodiments of portions of a compact thin film lithium-containing optical device.

FIGS. 18A-18B depict embodiments of portions of a compact thin film lithium-containing optical device.

FIGS. 19A-19B depict embodiments of portions of a compact thin film lithium-containing optical device.

FIG. 20 depicts an embodiment of portions of a compact thin film lithium-containing optical device.

FIGS. 21A-21B depict embodiments of portions of a compact thin film lithium-containing optical device.

FIGS. 22A-22C depict embodiments of portions of a compact thin film lithium-containing optical device.

FIGS. 23A-23C depict an embodiment of portions of a compact thin film lithium-containing optical device.

FIG. 24 depicts an embodiment of portions of a compact thin film lithium-containing optical device.

FIGS. 25A-25C depict embodiments of portions of a compact thin film lithium-containing optical device.

FIG. 26 depicts an embodiment of portions of a compact thin film lithium-containing optical device.

FIG. 27 depicts an embodiment of portions of a compact thin film lithium-containing optical device.

FIG. 28 is a flow chart depicting an embodiment of a method for providing a compact thin film lithium-containing optical device.

FIG. 29 is a flow chart depicting an embodiment of a method for providing a compact thin film lithium-containing optical device.

FIG. 30 is a flow chart depicting an embodiment of a method for providing a compact thin film lithium-containing optical device.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Thin film lithium-containing (TFLC) materials, such as thin film LN (TFLN) and/or thin film LT (TFLT), are electro-optic materials that exhibit the Pockels effect. TFLC materials are usable in electro-optic devices, such as photonic integrated circuits (PICs). TFLC PICs may provide high data rates and low losses, which are desirable in applications such as data communication and/or telecommunication. For example, a TFLC PIC may be desired to be used in conjunction with a silicon-based driver circuit, a silicon-based receiver, and/or other IC(s) such as processing unit(s) or similar IC(s).

Although TFLC PICs may be desired to be used, there continue to be barriers to their incorporation. For example, the ability to couple data signals into or out of ICs may be limited by the width of the TFLC PIC. For example, there may be a limited number of optical fibers that may be connected to a side of a TFLC PIC. This may translate to less data per unit time that may be provided to and/or from the TFLC PIC. A high bandwidth per millimeter of TFLC PIC width and/or a high bandwidth per fiber coupled to the TFLC PIC are desirable for high bandwidth optical communication using the TFLC PIC. In addition, components including PICs and other ICs are desired to be relatively densely packed. These features may translate to a TFLC PIC being desired to have a more compact size.

However, TFLC PICs, as well as other PICs, may have limitations in characteristics such as size, V-pi and electro-optic bandwidth. This is true of optical modulators, including TFLC optical modulators. For example, optical modulators may have a minimum length in the modulation region in order to provide the desired modulation of the optical signal. If the waveguides used in the optical modulators include bends in order to accommodate the length, the width of the optical modulator increases. Where multiple optical modulators are present on a PIC, there may also be cross talk between optical modulators. Typically, modulators have an increased separation in order to address crosstalk. These issues may translate to the optical modulator PIC having a larger width and occupying a larger area. Thus, the bandwidth per unit length of the PIC decreases and area consumed increases, which are undesirable.

Similarly, optical modulators may be long. In some cases, the larger length of the optical modulator allows for the desired modulation. The length may be further increased by the use of other passive optical devices that are part of the PIC but are outside of the modulation region. For example, optical coupling between a TFLC PIC and another PIC takes place in a coupling region. This coupling region is generally proximate to an edge of the TFLC PIC and distal from the region in which the optical signal is modulated (i.e., the modulation region). The presence of the coupling region increases the length of the TFLC PIC. Further, losses for coupling between the TFLC waveguide and another waveguide (e.g. on the same or another optical device) depend upon the distance (or gap) between the waveguides in the coupling region and the length of the coupling region. In order to have reduced losses for a given gap size, the coupling region in which the TFLC waveguide is proximate to the other waveguide is made longer. For example, the coupling region may have a length that is at least 500 micrometers, at least 1 millimeter, at least 1.5 millimeters or more. This may result in a significant increase in the length of the TFLC PIC. Longer optical modulators (i.e., longer PICs) may result in fewer components being packed into a given area. This may be undesirable. Thus, techniques for improving the use of TFLC PICs with other ICs are still desired.

An electro-optic device is described. The electro-optic device includes multiple optical modulators corresponding to multiple channels. Each optical modulator includes at least one thin film lithium-containing (TFLC) material. The optical modulators have a pitch of not more than two hundred micrometers. In some embodiments, each of the optical modulators further includes a waveguide and electrodes. The waveguide includes the TFLC material(s) and is configured to carry an optical signal. The electrodes are configured to carry an electrode signal for modulating the optical signal. The electrodes include a first electrode and a second electrode. A portion of the waveguide is between a first portion of a first electrode and a first portion of a second electrode. A second portion (e.g., a channel region) of the first electrode and a second portion (e.g., a channel region) of the second electrode are offset in a direction perpendicular-to-plane for the electro-optic device. Thus, at least part of the first electrode and the second electrode are vertically offset. In some embodiments, the second portion of the first electrode and the second portion of the second electrode are offset in another direction in-plane for the electro-optic device. In some embodiments, the optical device includes shielding between the optical modulators.In some embodiments, one or more of the electrodes includes extensions and a channel region. The extensions extending from the channel region. In some embodiments, the extensions may be solid integrated portions of the electrode. In other embodiments, there are spaces between the extensions. For example, such extensions may have a pitch. In some embodiments, a first portion of the extensions extends above the waveguide, while a second portion of the plurality of extensions extends below the waveguide.. In some embodiments, one or more of the channel regions includes aperture(s) therein. In some embodiments, one or more of the optical modulators includes lumped elements (e.g., elements having separate drivers and delay circuits).

In some embodiments, two adjacent channels of the channels are configured to carry counter-propagating signals. Thus, pairs of the modulators may carry opposite optical signals. In some embodiments, the pitch is not more than one hundred and thirty micrometers. Each of the optical modulators may have an electro-optic bandwidth of at least 120 GHz, a crosstalk with another of the optical modulators of less than thirty dB, a V-pi of at least 5 V, an optical loss of not more than 1 dB through an optical modulator of the optical modulators, and/or a length of at least 0.5 millimeter and not more than five millimeters.

In some embodiments, each of the modulators includes at least one electrode and a waveguide. A portion of each of the electrode(s) is in a modulation region and carries an electrode signal. The waveguide includes TFLC material(s). The waveguide may include a first portion, a second portion, and a third portion. The first portion is optically coupled with a first waveguide. The second portion is optically coupled with a second waveguide. The third portion is in the modulation region. Thus, an optical signal in the third portion is modulated by an electric field generated by the electrode signal. At least a part of the first portion and/or the second portion is aligned with the modulation region.

In some such embodiments, the electro-optic device is configured to support optical signals corresponding to a first transmission of at least 700 Gb/s per millimeter of width of the electro-optic device and/or second transmission of at least 800 Gb/s per optical fiber. In some embodiments, the first and second waveguides are on a photonics device coupled with the electro-optic device. In such embodiments, the electro-optic device and/or the photonics device include an interface configured to be coupled with an additional IC.

An electro-optic device including a waveguide and electrodes is described. The waveguide includes at least one TFLC material and is configured to carry an optical signal. The electrodes are configured to carry an electrode signal for modulating the optical signal. The electrodes include first and second electrodes. A portion of the waveguide is between a first portion of a first electrode and a first portion of a second electrode. A second portion of the first electrode and a second portion of the second electrode are offset in a direction perpendicular-to-plane for the electro-optic device.

A method is described. The method includes providing optical modulators of an electro-optic device. The optical modulators correspond to a plurality of channels. Each of the optical modulators includes at least one TFLC electro-optic material. The optical modulators have a pitch of not more than two hundred micrometers. In some embodiments, providing the optical modulators includes, for each of the modulators, providing a waveguide including the at least one TFLC material and configured to carry an optical signal. Providing the optical modulators may also include providing electrodes. The electrodes are configured to carry an electrode signal for modulating the optical signal. A portion of the waveguide is between a first portion of a first electrode and a first portion of a second electrode of the plurality of electrodes, a second portion of the first electrode and a second portion of the second electrode being offset in a direction perpendicular-to-plane for the electro-optic device. In some embodiments, a third portion of each of the electrodes is in a modulation region.

Providing the waveguide may also include providing a first portion, a second portion, and a third portion of the waveguide. The first portion is optically coupled with a first waveguide. The second portion is optically coupled with a second waveguide. The third portion is in the modulation region. The optical signal in the third portion of the waveguide is modulated by an electric field generated by the electrode signal. At least a part of at least one of the first portion and the second portion of the waveguide is aligned with the modulation region. In some embodiments, providing the electrodes further includes providing a plurality of extensions and a channel region. The extensions extend from the channel region. In some embodiments, the channel region includes at least one aperture therein or a first portion of the plurality of extensions extends above the waveguide and a second portion of the plurality of extensions extends below the waveguide.

Various features of the photonics devices are described herein. One or more of these features may be combined in manners not explicitly described herein. For example, the coupling region between TFLC waveguides and other waveguides (e.g., on the same or another optical device) that are aligned with the modulation region may be combined with electrodes that are vertically aligned/offset in at least the modulation region. Similarly, the electrodes used with the TFLC waveguides having a coupling region with other waveguides that is aligned with the modulation region may and/or may not include some combination of the extensions or electrodes having extended portions described herein. In another example, the electrodes that are vertically offset and/or used with the coupling region aligned with the modulation region may be configured as lumped electrodes. Further, although described primarily in the context of Mach-Zehnder modulators, other modulators may be used. Further, the electrodes and/or waveguides may be configured based on the cut (e.g., x-cut, y-cut, or z-cut) of the electro-optic materials used. Although described in the context of lithium-containing electro-optic materials (e.g., lithium niobate and/or lithium tantalate), in some embodiments, other materials exhibiting the Pockels effect may be used in addition to or in lieu of lithium-containing electro-optic materials. In addition, the drawings may not be to scale.

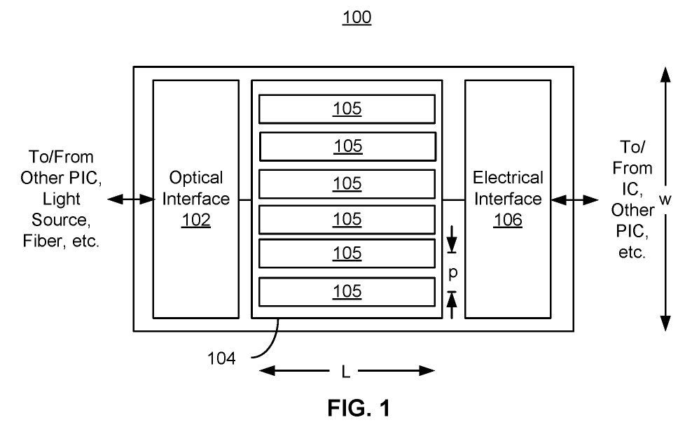

FIG. 1 is a block diagram of an embodiment of TFLC optical device 100 that may be compact and/or usable for applications such as data communication. TFLC optical device 100 is an electro-optic device and may be a TFLC PIC. Optical device 100 is thus described as a PIC. TFLC PIC 100 includes optical interface 102, TFLC electro-optics 104, and electrical interface 106. Electro-optics 104 includes multiple optical modulators 105. Other optical components may also be included in electro-optics 104. In some embodiments, communication to and/or from processing unit(s), PIC(s), and/or other IC(s) (e.g. individual IC(s) or a collection of networked ICs that may function together) may be provided via TFLC PIC 100. TFLC optical modulators 105 have a length L and a pitch p. TFLC PIC 100 also has a width w. Although shown as a standalone IC, TFLC PIC 100 may be mounted on or otherwise integrated with other chip(s), such as SiN/Si photonics chip(s). TFLC PIC 100 may include optical transmit functions only or may include optical transmit and receive functions. The transmission may be via TFLC optical modulators 105. Receive functions may utilize a photodiode (not shown) or other photodetector (not shown) mounted on or otherwise coupled with TFLC PIC 100. In some embodiments, receive functions may utilize a separate photonics IC having receive capabilities. TFLC PIC 100 provides for a high bandwidth signal transmission with a reduced width (e.g. including a low pitch for the optical modulators), and/or limited losses. Although shown as laid out across the surface of TFLC PIC 100, optical interface 102, TFLC electro-optics 104, and electrical interface 106 may have a different arrangement. For example, optical and/or electrical coupling may be made vertically (e.g. through gratings, evanescent coupling, or solder bumps) instead of at an edge of TFLC PIC 100. Further, components providing functions for optical interface 102 and/or electrical interface 106 may be present in and/or combined with portions of electro-optics 104.

Optical interface 102 for TFLC IC 100 (e.g. through which optical signals are coupled into or out of the TFLC IC) may be at the edge of TFLC IC 100, may be made vertically (e.g. through evanescent coupling and/or gratings), or in another manner. Optical interface 102 may be configured to be coupled with optical fibers (not shown), to another optical device, or to another component. For example, TFLC optical modulators 105 may be coupled to optical fibers directly at optical interface 102 (e.g. at an edge of TFLC PIC 100) or indirectly via another photonics component. Optical interface 102 may be coupled to another optical transmission media (e.g., free space). For example, the optical coupling through optical interface 102 may be via evanescent coupling, optical gratings, end-fire coupling, and/or other technique(s).

Electrical interface 106 (e.g. electrical connections) may be at or near the edge of TFLC IC 100, through from the top or bottom (e.g. using vias and solder bumps) of TFLC IC 100, or at another location. Electrical interface 106 is coupled with optical modulators 105. For example, electrical interface 106 may be used to provide electrode signals (e.g. microwave signals) used in modulating the optical signals for the channels carried by optical modulators 105. Electrical interface 106 may also be used to carry data signals corresponding to the optical signals. The electrical coupling to TFLC electro-optics 104 may be analog and/or digital. For example, electrical interface 106 may provide coupling via highly parallelized digital signals, such as via UCIe. In some embodiments, analog signals may be provided to electrical interface 106 and used to drive TFLC optical modulators 105.

Optical modulators 105 correspond to a plurality of channels carried by TFLC electro-optics 104. Each TFLC optical modulator 105 includes at least one TFLC material. For example, optical modulator 105 may include one or more waveguides including or consisting of TFLC material(s) such as TFLN and/or TFLT. In some embodiments, TFLC optical modulators 105 are configured in a modular fashion, where multiple TFLC modulators 105 are fabricated in a TFLC die with electrical and optical I/O connectors in interface 106 and 102, respectively. The TFLC dies may have modulators that support coherent modulation format. In some embodiments, TFLC optical modulators 150 may have a pitch, p, of less than 500 micrometers, of less than 300 micrometers, of less than 200 micrometers, of less than 150 micrometers, or of less than 100 micrometers. In addition, optical modulators 105 and thus electro-optics 104 may have a reduced length. In some embodiments, TFLC PIC 100 is configured to support optical signals corresponding to transmission of at least 700 Gb/s per millimeter of width, w, of TFLC PIC 100. TFLC PIC 100 may be configured to support optical signals corresponding to transmission of at least 800 Gb/s per optical fiber. TFLC modulators 105 may have a V-pi-L of at most 3 V-cm, at most 2 V-cm, at most 1.7 V-cm, at most 1.3 V-cm, at most 1 V-cm and at most 0.7 V-cm. TFLC modulators 105 may have a maximum length of 20 millimeters, 10 millimeters, 5 millimeters, 3 millimeters, 2 millimeters or 1 millimeter. TFLC modulators 100 may support an analog bandwidth of 75 GHz, 100 GHz, or more. TFLC modulator(s) 105 may each have an insertion loss of less than 3 dB, less than 2 dB, or less than 1 dB. TFLC modulator 105 may support an optical bandwidth of at least 1 nm, at least 3 nm, at least 5 nm, at least 10 nm, at least 20 nm, or at least 50 nm around the wavelength of operation.

In some embodiments, the size (e.g., L, p, and/or w), and/or performance characteristics (e.g., optical and/or microwave losses due to optical modulators 105) of TFLC PIC 100 are due to the configuration of electro-optics 104, optical interface 102, and electrical interface 106. For example, electrodes that are vertically aligned (or offset vertically) at least in the modulation region may be used in optical modulator(s) 105. This may reduce the pitch and, therefore, the width of TFLC PIC 100. Thus, a higher bandwidth per millimeter or per fiber may be achieved. A coupling region (e.g. in optical interface 102) that is aligned with the portion of the electrodes in the modulation region may also dramatically reduce the length of electro-optics 104. Optical modulators 105 may include TFLC waveguide(s) having multiple bends, may use electrode(s) having multiple extensions, may have a V-pi-L of not more than 3 V-cm, may have a maximum modulator 105 length (L) of 5 mm, and/or may include TFLC optical waveguide(s) that are fabricated using at least three etches and/or have an insertion loss of less than 2 dB per TFLC optical modulator 105.

Thus, the configurations described herein, such as the vertically offset electrodes and/or the coupling region aligned with the modulation region in combination with the use of TFLC and/or the configuration of the electrodes, may provide improved performance for applications such as data communication. For example, TFLC PIC 100 may support optical signals corresponding to transmission of at least 700 Gb/s per millimeter of width (w) of TFLC PIC 100 and/or may support optical signals corresponding to transmission of at least 800 Gb/s per optical fiber. In some embodiments, TFLC PIC 100 may be configured to support optical signals corresponding to transmission of at least 1.6 Tb/s per optical fiber coupled to TFLC PIC 100 or 1.5 Tb/s per millimeter of width of TFLC PIC 100 or at least 3 Tb/s per millimeter of width of TFLC PIC 100. Other numbers of bits per length may be possible depending upon the pitch of TFLC optical modulators 105 and the bit rate per modulator. The bit rate (e.g. 400 Gb/s or 800 Gb/s) of optical modulators 105 divided by the pitch (P) of modulators 105 (e.g. 200 micrometers, 125 micrometers, or 100 micrometers) may provide the bit rate per unit length for the TFLC PIC 100. In some embodiments, TFLC PIC 100 may support at least 200 Gb/s, at least 400 Gb/s, at least 600 Gb/s, or at least 800 Gb/s per optical modulator. Channels from multiple optical modulators may be encoded and transmitted in an optical fiber. Thus, TFLC PIC 100 may support at least 800 Gb/s per optical fiber, at least 1.6 Tb/s per optical fiber, at least 2.4 Tb/s per optical fiber, or at least 3.2 Tb/s per optical fiber. As a result, one or more TFLC PICs 100 may be used to provide communication to and/or from processing unit(s) and/or other components. Each optical modulator 105 may have an analog bandwidth of at least 75 GHz or an optical bandwidth of at least one nanometer around the operating wavelength. In some embodiments, optical modulators 105 may have a maximum width of 5 mm and/or an operating wavelength selected from 1260-1350 nm, or 850-1.1 um, or 1520-1670 nm, or 400-800 nm.

Thus, the described configurations and resulting performance characteristics may allow TFLC PIC 100 to be integrated as part of the optical I/O for high bandwidth communication or other applications. TFLC PICs 100 may be part of an optical solution that may preserve high performance, scalability, cost effectiveness while accelerating development cycles. TFLC PIC 100 may have standardized optical and electrical inputs/outputs that allows it to be designed independently of the other device (e.g. electrical chiplet/IC, other photonics chiplet/IC, or other application) to be integrated with TLFC PIC 100. In some embodiments, TFLC PIC 100 may be configured to be integrated without an additional (e.g. SiN/Si) photonics chiplet/IC. In some embodiments, TFLC PIC 100 may be configured for integration (e.g., flip-chip). TFLC PIC 100 may also be a standalone component.

TFLC PIC includes TFLC optical modulators 105 among other structures. For example, TFLC photonics device 100 may include waveguides, splitters, bends, mode converters, polarization beam rotators, and/or other optical components used to transmit and/or modify the optical signal carried by TFLC PIC 100. Electrodes may be used in conjunction with waveguide(s), for example for optical modulation (e.g. via the electro-optic effect).

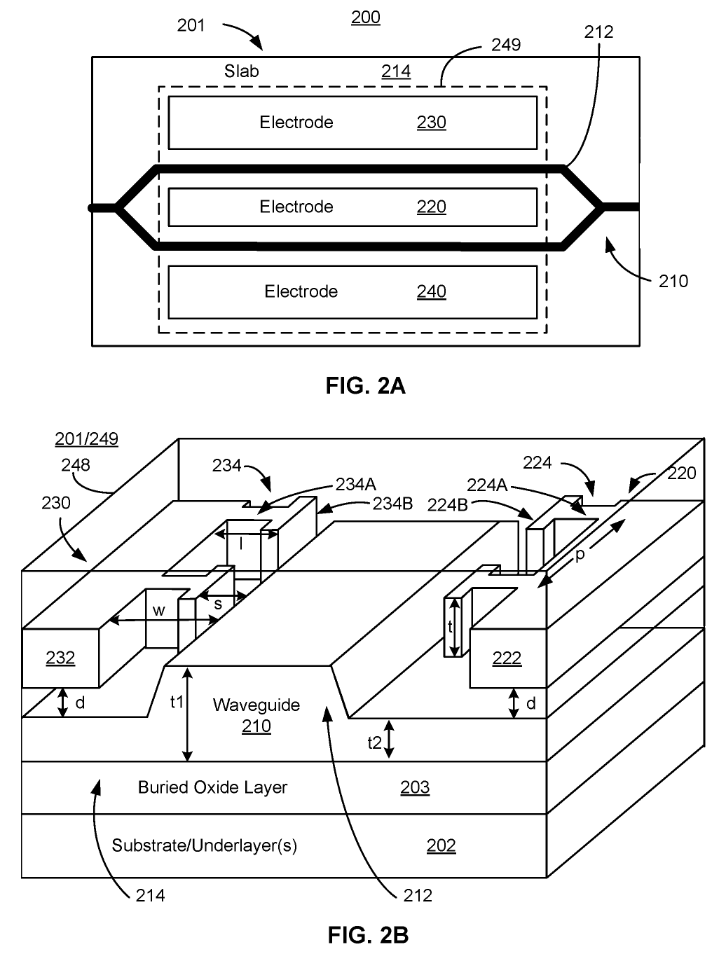

For example, FIGS. 2A-2B depict an embodiment of a portion of TFLC PIC 200 that may be used as part or all of a modulator used in TFLC photonics device 100. FIG. 2B is a perspective view of a portion of photonics device 200. FIGS. 2A-2B are not to scale. Only a portion of photonics device 200 is shown. Photonics device 200 may include other and/or additional structures that are not shown for simplicity. Further, although particular configurations are shown, other configurations are possible.

Photonics device 200 is on a substrate structure that includes substrate 202 and buried oxide (BOX) layer 203. In some embodiments, substrate 202 is a silicon substrate. Substrate 202 may also include other layers. In some embodiments, substrate 202 may be glass, quartz, silicon-on-insulator, and/or other low microwave loss dielectrics. Substrate 202 may be one hundred micrometers or more thick. BOX layer 203 may be a silicon dioxide layer. In some embodiments, BOX layer 203 may be at least three micrometers thick and not more than fifteen micrometers thick. In some embodiments, the substrate structure may be configured differently. Also shown is cladding 250, which may be formed of silicon dioxide. Substrate 202 (and/or other portions of photonics device 200) may be removed before final integration or other use of photonics device 200.

Photonics device 200 includes waveguide 210 and electrodes 220, 230, and 240. In some embodiments, photonics device 200 may be configured as or include a modulator (or portion thereof). Thus, photonics device 200 may be considered to include modulation region 249. Other regions, such as a bend region, may be present. Modulator 200 is shown as configured as a Mach-Zehnder modulator. Other configurations for phase and/or amplitude modulation are possible. For clarity, only the portion of electrodes 220, 230, and 240 proximate to waveguide 210 are shown. Stated differently, electrodes 220, 230, and 240 are shown in modulation region 260.

Waveguide 210 may be considered to include ridge 212 as well as slab 214. Ridge 212 has a height, t1, greater than the height, t2, of slab 214. Although shown as rectangles, ridge 212 and/or slab 214 have other shapes, such as trapezoids and/or other analogous shapes. In addition, slap 212 may terminate closer to ridge 214 than at least a portion of electrode(s) 220 and/or 230. Photonics device 200 includes electro-optic optic material(s), such as TFLC materials (e.g. TFLN and/or TFLT). More specifically, ridge 212 and slab 214 include electro-optic materials, such as TFLC materials. In some embodiments, the waveguide 210 consists of TFLC materials such as TFLN and/or TFLT. In the embodiment shown, ridge 212 and slab 214 are formed of the same material. In some embodiments, ridge 212 and slab 214 may include different materials. Waveguide 210, and more particularly ridge 212, may be used to propagate the optical signal. The optical mode may be well confined to ridge 212 and/or ridge 212 in combination with a portion of nearby slab 214. Slab 214 provides increased electro-optic modulation efficiency. In particular, slab 214 aids in directing the electric field generated by the signal(s) in electrodes 220, 230, and 240 to optical mode 213 in modulation region 260. Thus, a higher modulation for a given electric field may be obtained. As a result, V-pi (and V-pi-L) may be reduced.

In some embodiments, the TFLC layer from which TFLC waveguide 210 is formed has a thickness of less than two micrometers or less than one micrometer. Thus, TFLC waveguide 210 may have a thickness of less than two micrometers, less than one micrometer, less than six hundred nanometers, less than five hundred nanometers, or less than four hundred nanometers. The thickness of TFLC waveguide 210 may be at least fifty nanometers. In some embodiments, the TFLC layer has a thickness of at least two hundred and fifty nanometers. For example, TFLC waveguide 210 may be nominally three hundred nanometers or three hundred and fifty nanometers thick with, for example, a 10-15 nanometer variation. The thickness of TFLC waveguide 210 (e.g. t1, to the top of ridge 112) may be not more than three hundred nanometers, not more than three hundred and fifty nanometers, not more than four hundred nanometers, not more than five hundred nanometers, not more than six hundred nanometers, not more than seven hundred nanometers, not more than one micrometer, not more than 1.5 micrometer, and/or not more than two micrometers. In some embodiments, the thickness of TFLC waveguide 210 may be at least more than three hundred nanometers, at least three hundred and fifty nanometers, at least four hundred nanometers, at least five hundred nanometers, at least six hundred nanometers, at least seven hundred nanometers, at least one micrometer, or at least 1.5 micrometer.

The etches also form the sidewall angles for TFLC waveguide 110. The sidewall angles for ridge 112 and/or slab 114 may not exceed ninety degrees and are typically less than ninety degrees (e.g., not quite vertical). For example, the sidewall angles may be less than 85 degrees, less than 80 degrees, less than 75 degrees, and/or less than 70 degrees The sidewall angles may be desired to be steep. For example, the sidewall angles may be at least forty-five degrees, at least fifty-five degrees, or at least sixty degrees. The sidewalls may also have a lower surface roughness (e.g., less than ten nanometers), allowing for low optical losses in waveguides 210. TFLC waveguide 210 has a width (e.g., a smallest feature size) corresponding to the width of ridge 212. In some embodiments, the width of TFLC waveguide (i.e., TFLC optical structure) 210/ridge 212 is not more than one micrometer. This may be the smallest feature size for the TFLC waveguide 110. In some embodiments, the smallest feature size in the TFLC waveguide 110 is not more five hundred nanometers. In some such embodiments, the smallest feature size of TFLC waveguide 110 is not more than two micrometers or not more than one micrometer.

Electrodes 220, 230, and 240 may carry electrode signals used to modulate the optical signals (e.g. light) carried by waveguide 210 via electro-optic modulation. Electrode(s) 220 and/or 230 are configured to carry a traveling wave (e.g. a microwave or RF electrode signal) that modulates the optical signal carried by waveguide 210 via the electro-optic effect. For example, the electrode signals may provide electro-optic modulation up to frequencies of 100 GHz, 200 GHz, 500 GHZ or higher. In some embodiments, modulator 210 may provide modulation from at or near DC to frequencies of 100 GHz, 200 GHz, 500 GHz, or more. The modulation may also have a wide window, for example an operation bandwidth of at least 20 GHz. Electrode signals carried by electrodes 220, 230, and 240 may be configured in a variety of manners. For example, electrode 230 may carry a microwave signal, while electrodes 220 and 240 are ground. Electrode 230 may carry a signal of a first polarity, while electrodes 220 and 240 carry signals of opposite polarity (i.e. in a differential configuration). Other configurations (including but not limited to another number of electrodes) are possible.

Electrodes 220, 230, and/or 240 may include extensions. Embodiments of analogous electrodes may be found in co-pending U.S. Patent Application Serial No. 17/843,906, entitled ELECTRO-OPTIC DEVICES HAVING ENGINEERED ELECTRODES, which is a continuation of U.S. Patent Application No. 17/102,047 entitled ELECTRO-OPTIC DEVICES HAVING ENGINEERED ELECTRODES, filed November 23, 2020, which claims priority to U.S. Provisional Patent Application No. 62/941,139 entitled THIN-FILM ELECTRO-OPTIC MODULATORS filed November 27, 2019, U.S. Provisional Patent Application No. 63/033,666 entitled HIGH PERFORMANCE OPTICAL MODULATORS filed June 2, 2020, and U.S. Provisional Patent Application No. 63/112,867 entitled BREAKING VOLTAGE-BANDWIDTH LIMIT IN INTEGRATED LITHIUM NIOBATE MODULATORS USING MICRO-STRUCTURED ELECTRODES filed November 12, 2020, all of which are incorporated herein by reference for all purposes. In other embodiments, extensions may be omitted from some or all of electrodes 220, 230, and/or 240. Electrodes 220, 230, and 240 may carry differential electrical signals, a single electrical signal (e.g. a signal and ground), or other signal(s).

Electrode 230 includes a channel region 232 and extensions 234 (of which only one is labeled in FIG. 2B). Similarly, electrode 220 includes channel region 222 and extensions 224 (of which only one is labeled in FIG. 2B). In some embodiments, extensions 224 or 234 may be omitted from electrode 220 or electrode 230, respectively. Extensions 224 and 234 may be closer to ridge 212 than channel region 222 and 232, respectively, are. For example, the distance s from extensions 224 and 234 to waveguide ridge 212 is less than the distance w from channels 222 and 232 to waveguide ridge 212. Extensions 224 may be closer to electrode 230 (e.g. extensions 234 and/or channel 232) than channel 222 is. Similarly, extensions 234 may be closer to electrode 220 e.g. extensions 224 and/or channel 222) than channel 232 is.

Extensions 224 and 234 are in proximity to ridge 212. For example, extensions 224 and 234 are a vertical distance, d from slab 214 of TFLC waveguide 210. The vertical distance to TFLC waveguide 210 may depend upon the cladding 250 used. The distance d is highly customizable in some cases. For example, d may range from zero (or less if electrodes 220 and 230 contact or are embedded in slab portion 214) to greater than the height of ridge 212. In embodiments in which slab 214 terminates closer to ridge 212 than channel regions 222 and 232, d may be zero (same level as the top surface of slab 214), positive (further from substrate 202 than the top surface of slab 214), or negative (further from substrate 202 than the top surface of slab 214). However, d is generally still desired to be sufficiently small that electrodes 220 and 230 can apply the desired electric field to ridge 212. Extensions 224 and 234 are also a distance, s, from ridge 212. In some embodiments, s < 0 (i.e., extensions 224 and/or 234 may extend over the top of ridge 212 or below waveguide 210). Extensions 224 and 234 are desired to be sufficiently close to TFLC waveguide 210 (e.g. close to ridge 212) that the desired electric field and index of refraction change can be achieved. However, extensions 224 and 234 are desired to be sufficiently far from TFLC waveguide 210 (e.g. from ridge 212) that their presence does not result in undue optical losses. Although shown next to ridge 212, extensions 224 and/or 234 may extend above and/or below ridge 212.

In the embodiment shown, extensions 224 have a connecting portion 224A and a retrograde portion 224B. Retrograde portion 224B is so named because a part of retrograde portion may be antiparallel to the direction of signal transmission through electrode 220. Similarly, extensions 234 have a connecting portion 234A and a retrograde portion 234B. Thus, extensions 224 and 234 have a “T”-shape. In some embodiments, other shapes are possible. For example, extensions 224 and/or 234 may have an “L”-shape, may omit the retrograde portion, may be rectangular, trapezoidal, parallelogram-shaped, may partially or fully wrap around a portion of ridge 212, and/or have another shape. Similarly, channel regions 222 and/or 232, which are shown as having a rectangular cross-section, may have another shape. Further, extensions 224 and/or 234 may be different sizes. Although all extensions 224 and 234 are shown as the same distance from ridge 212, some of extensions 224 and/or some of extensions 234 may be different distances from ridge 212. Channel regions 222 and/or 232 may also have a varying size.

Also indicated in FIG. 2B is thickness, t, of extensions 224 and 234. In the embodiment shown, channels 222 and 232 have the same thickness. In some embodiments, the thickness of extensions 224 and/or 234 may vary. For example, extensions 224 may be thinner (or thicker) than extensions 234. Further, different extensions 224 may have different thicknesses. Similarly, different extensions 234 may have different thicknesses. Extensions 224 and/or 234 may also have a different thickness than channels 222 and/or 232. For example, extensions 224 and/or 234 may be thinner (or thicker) than channels 222 and/or 232. Different portions of extensions 224 and/or 234 may also have different thicknesses. For example, retrograde portions 224B and/or 234B may be thinner (or thicker) than connecting portions 224A and/or 234B. Thus, TFLC PICs 200 and 100 may have a variety of configurations, components, and functions. Performance of TFLC PICs 200 and 100 may be superior to that of other, non-TFLC PICs.

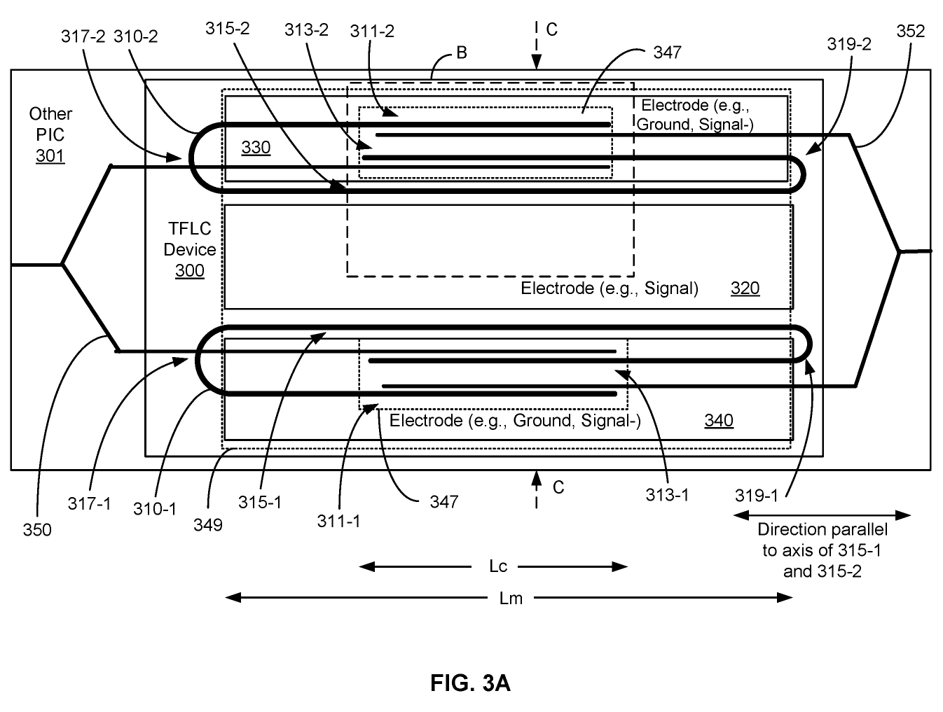

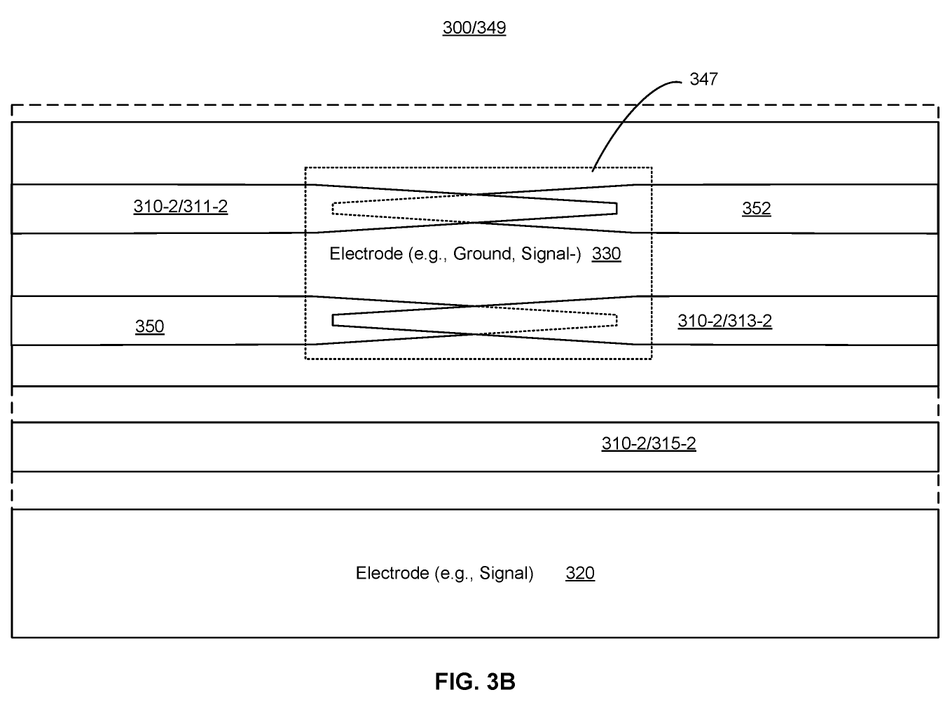

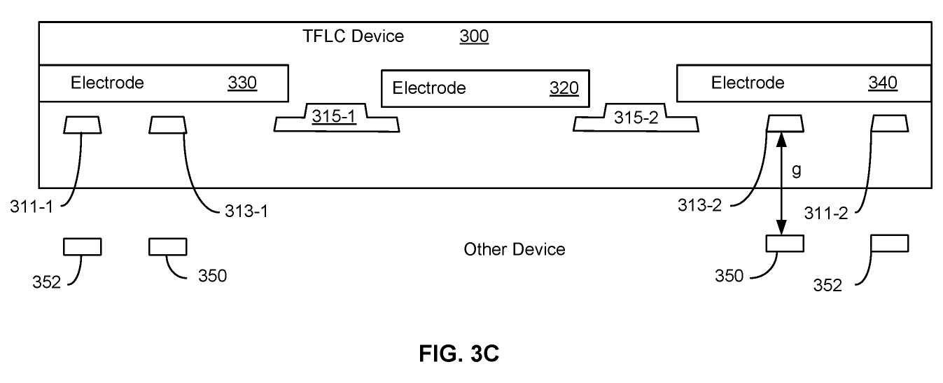

FIGS. 3A-3C depict an embodiment of a portion of compact TFLC optical device 300 usable in applications such as data communication. TFLC optical device 300 may be or be part of a TFLC PIC such as TFLC PIC 100. Thus, TFLC optical device 300 is described as a TFLC PIC 300. TFLC PIC 300 is also in the form of an optical modulator analogous to optical modulator 105. However, TFLC PIC 300 may have other and/or additional function(s). Also shown is the environment in which TFLC optical device 300 may be used. Thus, another PIC 301 which includes waveguides 350 and 352 is also shown. For example, PIC 301 may be a SiN or SiP PIC having SiN or Si waveguides 350 and 352. FIG. 3A depicts a plan view of TFLC PIC 300. FIG. 3B depicts a plan view of region B indicated by dashed lines in FIG. 3A. FIG. 3C depicts a cross-sectional view of TFLC PIC 300 taken along a surface indicated by dashed arrows C in FIG. 3A.

Referring to FIGS. 3A-3C, TFLC PIC 300 includes waveguides 310-1 and 310-2 (collectively or generically waveguides 310) and electrodes 320, 330, and 340. In some embodiments, electrode 320 carries an electrode signal used in modulating the optical signals carried by waveguides 310, while electrodes 330 and 340 are grounds. In other embodiments, electrodes 320, 330, and 340 may be configured differently. For example, electrodes 320, 330, and 340 may be configured in a differential mode. For example, electrode 320 may carry a particular positive signal (S) and electrodes 320 and 340 may carry the negative signal (S-, which is opposite in polarity to signal S). Although termed S- (or a negative signal), in a differential mode, the signals need not have opposite values. For example, there may be a DC shift and/or the signal S may be considered the negative signal, with the signal S- being the positive signal. Although shown as having a simple shape, electrodes 320, 330, and/or 340 may be configured differently (e.g., having extensions, apertures, portions which have a perpendicular-to-plane components, apertures, and/or other features).

Waveguides 310 are TFLC waveguides. Thus, waveguides 310 include or are formed of TFLC electro-optic materials. Waveguide 310-1 includes first portion 311-1, second portion 313-1, and third portion 315-1, while waveguide 310-2 includes first portion 311-2, second portion 313-2, and third portion 315-2 (collectively or generically first portion 311, second portion 313, and third portion 315). Similarly, waveguide 310-1 includes bends 317-1 and 319-1, while waveguide 310-2 includes bends 317-2 and 319-2 (collectively or generically bends 317 and 319). Although two bends 317 and 319 are shown for each waveguide 310, in some embodiments, waveguide(s) 310-1 and/or 310-2 may have another number of bends. For example, if multiple modulation regions 349 are present, waveguide(s) 310 may include additional bends. In such embodiments, electrodes 320, 330, and/or 340 may also include bends. For example, electrodes 320, 330, and/or 340 may have U-shape or S-shape bends. In such embodiments, the coupling regions 347 may still be under metal/aligned with modulation region 349 but may be vertically shifted relative to the input/output. TFLC waveguides 310 may be analogous to waveguide 210. For example, waveguides 310 may include a slab portion and a ridge analogous to slab 214 and ridge 212. An embodiment of such a configuration of portions 315 may be seen in FIG. 3C.

Third portions 315 of TFLC waveguides 310 are proximate to the electrodes 320, 330, and 340 in modulation region 349 having modulation length Lm. Modulation region 349 may be considered a region in which portions 315 of waveguides 310 are sufficiently close to electrodes 320, 330, and/or 340 that an electric field due to electrode signal(s) in electrode(s) 320, 330, and/or 340 modulates the optical signal carried in waveguides 310. The modulation region may also be considered to include the electrodes 320, 330, and 340. In some embodiments, portions 315 of TFLC waveguides 310 are x-cut (or w-cut) TFLC materials. Thus, the electric field that modulates the optical signal in waveguides 310 is generally between electrode 320 and electrodes 330 or 340 and may have a substantial component in-plane. Such an electric field may modulate the optical signal in waveguides 310. In contrast, although electrodes 330 and 340 may be considered part of modulation region, electrodes 330 and 340 may not generate an electric field that significantly modulates the optical signal in portions 311 and 313 of waveguides 310. For example, electrodes 330 and 340 may be ground, may not generate a significant in-plane electric field (for x- and/or y-cut TFLC electro-optic materials) in the region of portions 311 and 313 of waveguides 310, and/or may be sufficiently far from portions 311 and 313 of waveguides 310 that any electric field generated does not significantly modulate the optical signal in portions 311 and 313. Because of the configuration and/or fabrication of portions 315 of waveguides 310 and electrodes 320, 330, and 340, characteristics such as the optical losses, bit rate, bandwidth, V-pi, V-pi-L, and/or other performance benchmarks described herein may be achieved using modulation region 349.

First portions 311 of waveguides 310 are optically coupled with waveguide 352 in coupling region 347. Similarly, second portions 313 of waveguides 310 are optically coupled with waveguide 350 in coupling region 347. Thus, although within optical modulator of TFLC PIC 300, coupling regions 347 may be considered analogous to optical interface 102. Waveguides 310 are coupled with waveguides 350 and 352 through a gap of length, g, via evanescent coupling. Thus, waveguides 310 may not directly contact waveguides 350 and 352.

The length of coupling region 347 (i.e. the length at which waveguides 310 are proximate to waveguides 350 and 352 to be optically coupled) is Lc. Although the coupling length Lc and gap g is shown as the same for all waveguides 310, 350, and 352, the coupling length and/or gap may vary for waveguides 310, 350, and/or 352. In the embodiment shown, portions 311 and 313 of waveguides 310 are tapered. Portions of waveguides 350 and 352 are also tapered. Although tapering is shown in plane, tapering may be in-plane and/or in other direction(s) (e.g. perpendicular to plane). In some embodiments, tapering of one or more of portion(s) 311, portion(s) 313, waveguide 350, and/or waveguide 352 may be omitted. Tapering of portions 311 and 313 of waveguides 310 and of waveguides 350 and 352 may facilitate optical coupling between waveguides 310 and waveguides 350 and 352. Tapering to a smaller waveguide size may expand the mode size. This may increase the interaction with the optical signal carried by one waveguide with a nearby waveguide, facilitating coupling. For example, if waveguide 350 carries an input optical signal, tapering of waveguide 350 near portions 313 expands the mode size. The tapered portions 313 of waveguides 310 may better able to support a larger mode size. Optical coupling may thus be improved. As portions 313 increase in cross-sectional area, the mode may be better confined for transmission by waveguides 310. An analogous interaction may take place between waveguides 310 and waveguide 352 for optical signals exiting via waveguide 352.

Portions 311 and 313 of waveguides 310 are aligned with modulation region 349. In TFLC PIC 300, modulation region 349 includes the portions shown of electrodes 320, 330, and 340, as well as portions 315 of waveguides 310. Thus, portions 311 and 313 of waveguides 310 may be considered to be entirely aligned (e.g., aligned in a direction parallel to the axis of portions 315 and in a direction perpendicular to the axis of portions 315) modulation region 349. Stated differently, as seen from the plan views of FIGS. 3A and 3B, coupling regions 347 are within modulation region 349. Although shown as below electrodes 330 and 340, portions 311 and 313 may be above or below or closer to/further from an underlying dielectric layer. In some embodiments, portions 311 and 313 of waveguide(s) 310 may not be aligned with modulation region 349 in a direction perpendicular to the axis of portion(s) 315 of waveguide(s) 310. In such embodiments, portions 311 and 313 may be further from electrode 320 than electrodes 330 and 340 are. In some embodiments, portion(s) 311 and/or 313 of waveguide(s) 310 may extend beyond modulation region 349 in the direction parallel to the axis of portion 315. In such embodiments, portion(s) 311 and/or 313 (and thus coupling regions 347) may be only partially aligned with modulation region 349.

In operation, an optical signal may be provided to TFLC PIC 300 by waveguide 352. The optical signal is split and couples to waveguides 310 via portions 311 in coupling regions 347. The optical signal travels in waveguides 310 through bends 317. The optical signal is modulated in portions 315 by electrode signal(s) carried in electrodes 320, 330, and/or 340. The modulated optical signal travels through bends 319 and couples to waveguide 350 via portions 313 in coupling regions 347. In the embodiment shown, an optical signal input through waveguide 350 may be coupled and modulated in a similar manner and output through waveguide 350.

TFLC PIC 300 may provide the desired optical modulation while having a compact length and reduced (or acceptable) coupling losses in coupling regions 347. As discussed for TFLC PICs 100 and 200, waveguides 310 and electrodes 320, 330, and 340 may be configured to have the desired optical modulation, a reduced V-pi and/or V-pi-L, desired bandwidth, optical losses, and/or other characteristics. Optical coupling losses between waveguides 310 and waveguides 350 and 352 depend upon the gap, g, and the coupling length, Lc. Coupling losses may be mitigated by reducing the gap (g decreased) between portions 310 and 311 and waveguides 350 and 352. However, a reduction in the gap may increase fabrication difficulty and/or reduce alignment tolerances. Consequently, decreasing the gap between portions 311 and 313 of TFLC waveguides 310 and waveguides 350 and/or 352 to decrease coupling losses may not provide an acceptable solution for a low loss optical modulator. Thus, conventional coupling regions have a larger gap and long coupling regions proximate to the edges of the PIC, extending the length of the modulator by, e.g., 500 micrometers through 1.5 millimeters or more.

However, portions 311 and 313 of waveguides 310 and coupling regions 347 may not extend the length of TFLC PIC 300 significantly or at all. In some embodiments, coupling region(s) 347 are entirely aligned with modulation region 349 (e.g., as shown in FIGS. 3A-3B for coupling regions 347). For example, the tapers of 311, 313, 350 and 352 (e.g., coupling regions 347) may be aligned with outside electrodes 330 and 340 (e.g. ground electrodes) along a direction parallel to the axis of portions 315. In some embodiments, the tapers of regions 311, 313, 350, and 352 may be aligned with outside electrodes 330 and 340 in a direction perpendicular to the axis of portions 315 of waveguide 310. Thus, as in TFLC PIC 300, portions 311 and 313 may be below (or above) electrodes 320 and 340.

Because portions 311 and 313 of waveguides 310 (and coupling regions 347) may be considered within modulation region 340, additional area need not be occupied by coupling regions 347. For example, portions 311 and 313 may be as long as 500 micrometers, as long as 1 millimeter or more without extending beyond modulation region 349. For example, each coupling region 347 may be at least 1/5 of the electrode length in modulation region 349 (Lc ≥ Lm/5), at least ¼ of the electrode length in modulation region (Lc ≥ Lm/4), at least ½ of the electro length in modulation region 349 (Lc ≥ Lm/2), and not longer than the electrode in modulation region 349 (Lc ≤ Lm). In some embodiments, modulation region 349 may be at least one millimeter, at least two millimeters, at least five millimeters, at least one centimeter, at least two centimeters, and not more than ten centimeters. Thus, coupling region(s) 347 may be made long (e.g. at least 200 micrometers, at least 300 micrometers, at least 500 micrometers, at least 1 millimeter, or at least two millimeters) without increasing the length of TFLC PIC 300. Thus, a long transition in coupling regions 347 and reduced optical coupling losses may be provided without reducing the gap size (which may adversely affect fabrication) or extending the length of TFLC PIC 300. For example, the gap size, g, may be tailored as desired (e.g. at least 50 nanometers, not more than 200 nanometers, not more than 400 nanometers, not more than 500 nanometers, and/or not more than one micrometer) without increasing the length, L, of the TFLC PIC 300.

In addition, TFLC waveguides 310 each have two turns 317 and 319. In some embodiments, the TFLC waveguides 310 are configured to have a small bending radius (e.g. less than 200 micrometers, less than 150 micrometers, less than 100 micrometers, less than 80 micrometers, less than 50 micrometers, less than 30 micrometers, less than 25 micrometers, less than 20 micrometers, less than 10 micrometers and at least 5 micrometers). This small bending radius may reduce the width of TFLC PIC 300 and allow coupling regions 347 to be under electrodes 330 and 340 while portions 315 of waveguides 310 are within the space between electrode 320 and electrodes 330 and 340. For a TFLC including multiple optical modulators, such a reduced bending radius may be configured to provide the desired pitch. For example, the desired pitch may be less than 200 micrometers, not more than 150 micrometers, not more than 130 micrometers, or not more than 125 micrometers, or not more than 120 micrometers. For one hundred and eighty degree bends 317 and 319, the bending radius may be not more than ¼ the desired pitch (e.g. not more than 40 micrometers for 120 micrometer pitch). Although one hundred and eighty degree bends (e.g. 170-190 degrees) are shown, other angles may be used.

TFLC PIC 300 may share the benefits of TFLC PICs 100 and/or 200. In addition, TFLC PIC 300 may have a reduced length while providing desired low loss optical coupling between TFLC waveguides 310 and other waveguides 350 and 352. For lower bending radii, the desired pitch (e.g. width of TFLC PIC 300) may be achieved with the lower optical coupling losses. Other waveguides 350 and 352 may be on TFLC PIC 300, may be on another optical devices such as PIC 301, or otherwise located. Consequently, integration and performance of TFLC PIC 300 may be improved without adversely affecting fabrication (e.g., by reducing the size of the gap, g). TFLC PIC 300 may provide the features such as bit rate per unit length or bit rate per optical fiber described herein. For example, TFLC PIC 300 may be used in or as TFLC PIC 100 and in conjunction with other PIC 301. Thus, performance may be improved.

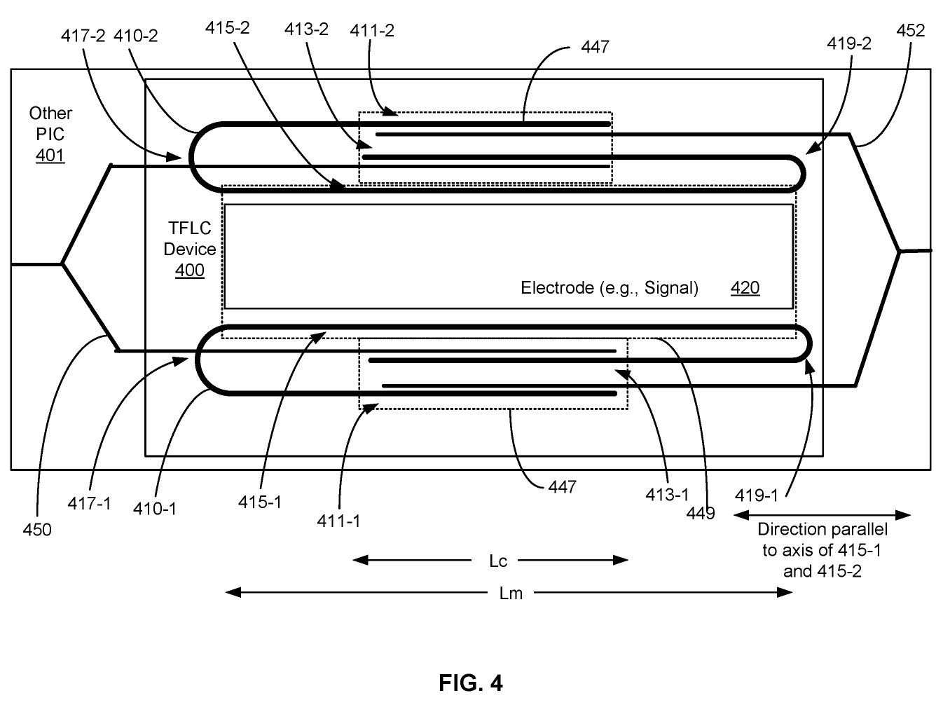

FIG. 4 depicts a plan view of an embodiment of a portion of compact TFLC optical device 400 usable in applications such as data communication. TFLC optical device 400 may be or be part of a TFLC PIC such as TFLC PIC 100. Thus, TFLC optical device 400 is described as a TFLC PIC 400. TFLC PIC 400 is also in the form of an optical modulator analogous to optical modulator 105. However, TFLC PIC 400 may have other and/or additional function(s). Also shown is the environment in which TFLC optical device 400 may be used. Thus, another PIC 401 which includes waveguides 450 and 452 is also shown. For example, PIC 401 may be a SiN or SiP PIC having SiN or Si waveguides 450 and 452.

TFLC PIC 400 is analogous to TFLC PIC(s) 100, 200, and/or 300. Thus, TFLC PIC 400 includes waveguides 410-1 and 410-2 (collectively or generically waveguides 410) and electrode 420 that are analogous to waveguides 310-1 and 310-2 and electrode 320. Waveguide 410-1 includes first portion 411-1, second portion 413-1, and third portion 415-1 analogous to portions 311-1, 313-1 and 315-1, while waveguide 410-2 includes first portion 411-2, second portion 413-2, and third portion 415-2 analogous to portions 311-2, 313-2 and 315-2 (collectively or generically first portion 411, second portion 413, and third portion 415). Similarly, waveguide 410-1 includes bends 417-1 and 419-1 analogous to bends 317-1 and 319-1, while waveguide 410-2 includes bends 417-2 and 419-2 analogous to bends 317-2 and 319-2 (collectively or generically bends 417 and 419). In some embodiments, electrode 420 carries an electrode signal used in modulating the optical signals carried by waveguides 410. TFLC PIC 400 also includes coupling regions 447 and modulation region 449 that are analogous to coupling regions 347 and modulation region 349.

Portions 411 and 413 of waveguides 410, and thus coupling regions 447, are aligned with modulation region 449 in a direction parallel to the axis of portions 415 of waveguides 410. Thus, as for coupling regions 347, coupling regions 447 may provide the desired optical losses and the desired gap length without increasing the length of TFLC PIC 400. However, in a direction perpendicular to the axis of portions 415, coupling regions 447 are not aligned with modulation region 449. Thus, coupling regions 447 are outside of modulation region 449.

TFLC PIC 400 may share benefits of TFLC PIC(s) 100, 200, and/or 300. TFLC PIC 400 may have a reduced length while providing desired low loss optical coupling between TFLC waveguides 410 and other waveguides 450 and 452. For lower bending radii, the desired pitch (e.g. width of TFLC PIC 400) may be achieved with the lower optical coupling losses. Other waveguides 450 and 452 may be on TFLC PIC 400, may be on another optical devices such as PIC 401, or otherwise located. Consequently, integration and performance of TFLC PIC 400 may be improved without adversely affecting fabrication (e.g., by reducing the size of the gap, g). TFLC PIC 400 may provide the features such as bit rate per unit length or bit rate per optical fiber described herein. For example, TFLC PIC 400 may be used in or as TFLC PIC 100 and in conjunction with other PIC 401. Thus, performance may be improved.

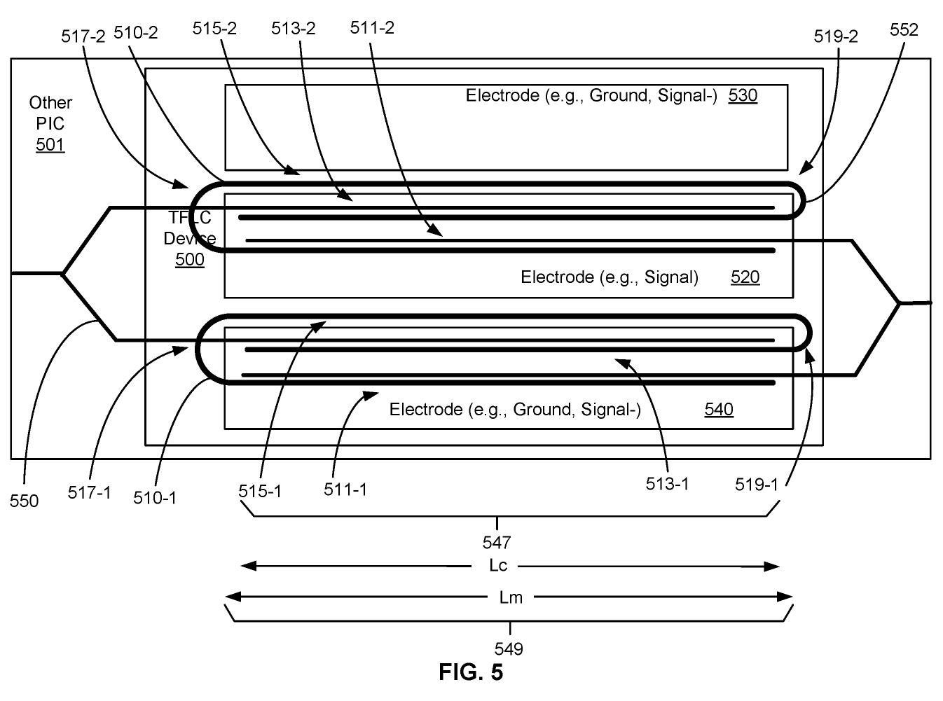

FIG. 5 depicts a plan view of an embodiment of a portion of compact TFLC optical device 500 usable in applications such as data communication. TFLC optical device 500 may be or be part of a TFLC PIC such as TFLC PIC 100. Thus, TFLC optical device 500 is described as a TFLC PIC 500. TFLC PIC 500 is also in the form of an optical modulator analogous to optical modulator 105. However, TFLC PIC 500 may have other and/or additional function(s). Also shown is the environment in which TFLC optical device 500 may be used. Thus, another PIC 501 which includes waveguides 550 and 552 is also shown. For example, PIC 501 may be a SiN or SiP PIC having SiN or Si waveguides 550 and 552.

TFLC PIC 500 is analogous to TFLC PIC(s) 100, 200, 300 and/or 400. Thus, TFLC PIC 500 includes waveguides 510-1 and 510-2 (collectively or generically waveguides 510) and electrodes 520, 530, and 540 that are analogous to waveguides 310-1 and 310-2 and electrodes 320, 330, and 340. Waveguide 510-1 includes first portion 511-1, second portion 513-1, and third portion 515-1 analogous to portions 311-1, 313-1 and 315-1, while waveguide 510-2 includes first portion 511-2, second portion 513-2, and third portion 515-2 analogous to portions 311-2, 313-2 and 315-2 (collectively or generically first portion 511, second portion 513, and third portion 515). Similarly, waveguide 510-1 includes bends 517-1 and 519-1 analogous to bends 317-1 and 319-1, while waveguide 510-2 includes bends 517-2 and 519-2 analogous to bends 317-2 and 319-2 (collectively or generically bends 517 and 519). In some embodiments, electrode(s) 520, 530, and/or 540 carry electrode signal(s) used in modulating the optical signals carried by waveguides 510. TFLC PIC 500 also includes coupling regions 547 and modulation region 549 that are analogous to coupling regions 347 and modulation region 349.

Portions 511-2 and 513-2 of waveguide 510-2 are aligned with modulation region 549. However, portions 511-2 and 513-2 of waveguide 510-2, as well as the corresponding coupling region 547, are vertically aligned with signal electrode 520 (i.e., instead of ground electrode 530). In an analogous embodiment, portions 511-2 and 513-2 and the corresponding coupling region 547 may be aligned with electrode 530, while portions 511-1 and 513-1 and the corresponding coupling region 547 may be aligned with electrode 520. In addition, the coupling region has been extended along the direction parallel to the axis of portions 515 to be close to the modulation length Lm. Thus, coupling regions 547 are within modulation region 549 in the plan view of FIG. 5. As for coupling regions 347, coupling regions 547 may provide the desired optical losses and the desired gap length without increasing the length of TFLC PIC 500. In addition, the width of TFLC PIC 500 may not be increased by coupling regions 547.

TFLC PIC 500 may share benefits of TFLC PIC(s) 100, 200, 300, and/or 400. TFLC PIC 500 may have a reduced length while providing desired low loss optical coupling between TFLC waveguides 510 and other waveguides 550 and 552. For lower bending radii, the desired pitch (e.g. width of TFLC PIC 500) may be achieved with the lower optical coupling losses. Other waveguides 550 and 552 may be on TFLC PIC 500, may be on another optical devices such as PIC 501, or otherwise located. Consequently, integration and performance of TFLC PIC 500 may be improved without adversely affecting fabrication (e.g., by reducing the size of the gap, g). TFLC PIC 500 may provide the features such as bit rate per unit length or bit rate per optical fiber described herein. For example, TFLC PIC 500 may be used in or as TFLC PIC 100 and in conjunction with other PIC 501. Thus, performance may be improved.

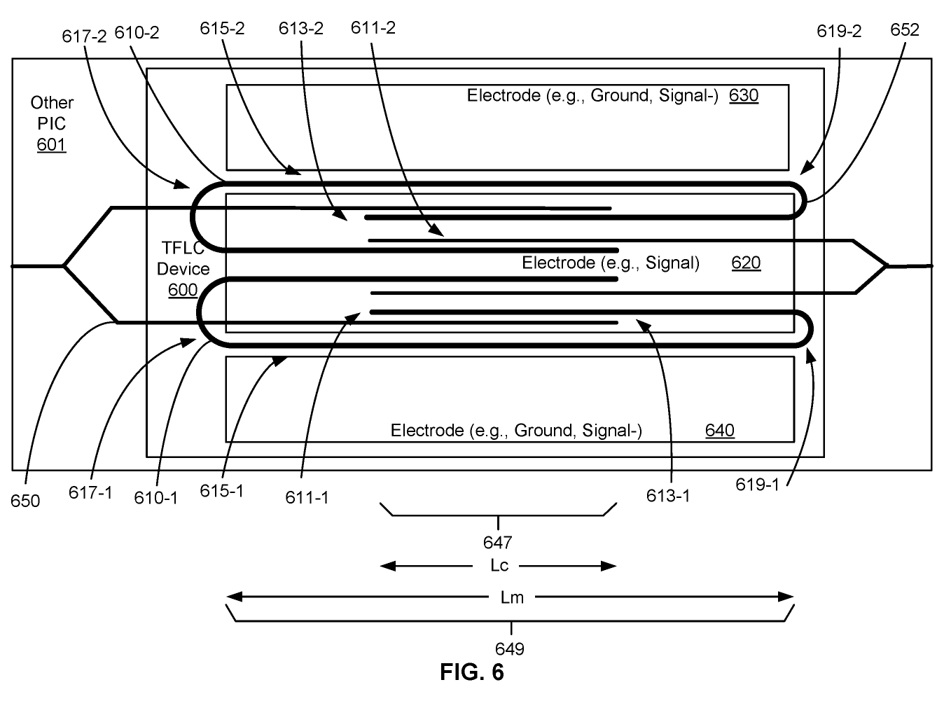

FIG. 6 depicts a plan view of an embodiment of a portion of compact TFLC optical device 600 usable in applications such as data communication. TFLC optical device 600 may be or be part of a TFLC PIC such as TFLC PIC 100. Thus, TFLC optical device 600 is described as a TFLC PIC 600. TFLC PIC 600 is also in the form of an optical modulator analogous to optical modulator 105. However, TFLC PIC 600 may have other and/or additional function(s). Also shown is the environment in which TFLC optical device 600 may be used. Thus, another PIC 601 which includes waveguides 650 and 652 is also shown. For example, PIC 601 may be a SiN or SiP PIC having SiN or Si waveguides 650 and 652.

TFLC PIC 600 is analogous to TFLC PIC(s) 100, 200, 300, 400 and/or 500. Thus, TFLC PIC 600 includes waveguides 610-1 and 610-2 (collectively or generically waveguides 610) and electrodes 620, 630, and 640 that are analogous to waveguides 310-1 and 310-2 and electrodes 320, 330, and 340. Waveguide 610-1 includes first portion 611-1, second portion 613-1, and third portion 615-1 analogous to portions 311-1, 313-1 and 315-1, while waveguide 610-2 includes first portion 611-2, second portion 613-2, and third portion 615-2 analogous to portions 311-2, 313-2 and 315-2 (collectively or generically first portion 611, second portion 613, and third portion 615). Similarly, waveguide 610-1 includes bends 617-1 and 619-1 analogous to bends 317-1 and 319-1, while waveguide 610-2 includes bends 617-2 and 619-2 analogous to bends 317-2 and 319-2 (collectively or generically bends 617 and 619). In some embodiments, electrode(s) 620, 630, and/or 640 carry electrode signal(s) used in modulating the optical signals carried by waveguides 610. TFLC PIC 600 also includes coupling regions 647 and modulation region 649 that are analogous to coupling regions 347 and modulation region 349.

Portions 611 and 613 of waveguides 610 are aligned with modulation region 649. However, portions 611 and 613 of waveguides 610, as well as corresponding coupling regions 647, are vertically aligned with signal electrode 620 (i.e., instead of ground electrodes 630 and 640). Thus, coupling regions 647 are within modulation region 649 in the plan view of FIG. 6. As for coupling regions 347, coupling regions 647 may provide the desired optical losses and the desired gap length without increasing the length of TFLC PIC 600. In addition, the width of TFLC PIC 600 may not be increased by coupling regions 647.

TFLC PIC 600 may share benefits of TFLC PIC(s) 100, 200, 300, 400, and/or 500. TFLC PIC 600 may have a reduced length while providing desired low loss optical coupling between TFLC waveguides 610 and other waveguides 650 and 652. For lower bending radii, the desired pitch (e.g. width of TFLC PIC 600) may be achieved with the lower optical coupling losses. Other waveguides 650 and 652 may be on TFLC PIC 600, may be on another optical devices such as PIC 601, or otherwise located. Consequently, integration and performance of TFLC PIC 600 may be improved without adversely affecting fabrication (e.g., by reducing the size of the gap, g). TFLC PIC 600 may provide the features such as bit rate per unit length or bit rate per optical fiber described herein. For example, TFLC PIC 600 may be used in or as TFLC PIC 100 and in conjunction with other PIC 601. Thus, performance may be improved.

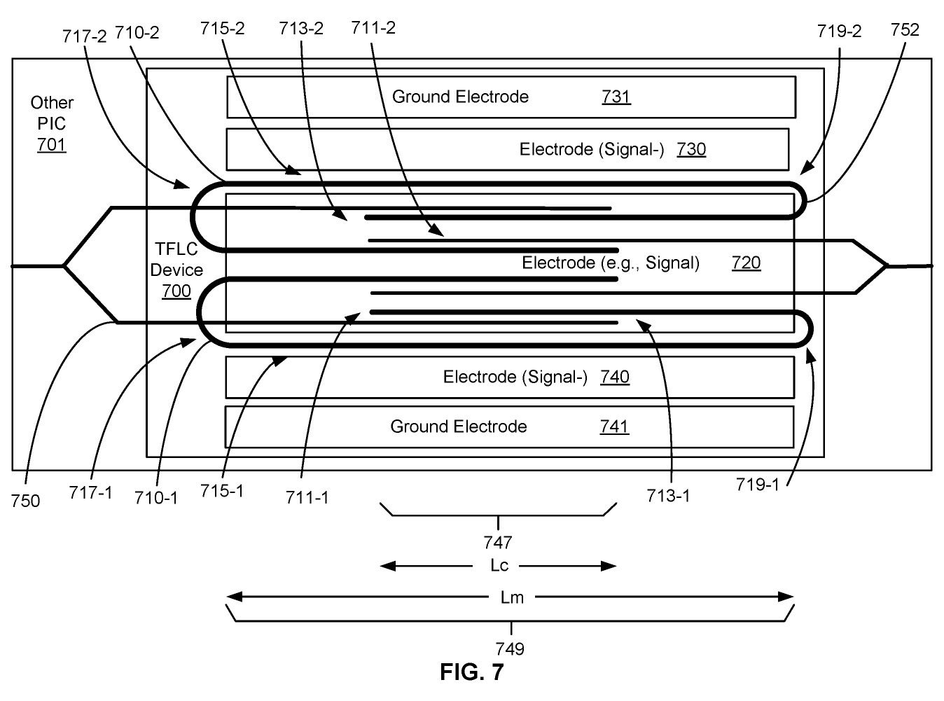

FIG. 7 depicts a plan view of an embodiment of a portion of compact TFLC optical device 700 usable in applications such as data communication. TFLC optical device 700 may be or be part of a TFLC PIC such as TFLC PIC 100. Thus, TFLC optical device 700 is described as a TFLC PIC 700. TFLC PIC 700 is also in the form of an optical modulator analogous to optical modulator 105. However, TFLC PIC 700 may have other and/or additional function(s). Also shown is the environment in which TFLC optical device 700 may be used. Thus, another PIC 701 which includes waveguides 750 and 752 is also shown. For example, PIC 701 may be a SiN or SiP PIC having SiN or Si waveguides 750 and 752.

TFLC PIC 700 is analogous to TFLC PIC(s) 100, 200, 300, 400, 500 and/or 600. Thus, TFLC PIC 700 includes waveguides 710-1 and 710-2 (collectively or generically waveguides 710) and electrodes 720, 730, and 740 that are analogous to waveguides 310-1 and 310-2 and electrodes 320, 330, and 340. Waveguide 710-1 includes first portion 711-1, second portion 713-1, and third portion 715-1 analogous to portions 311-1, 313-1 and 315-1, while waveguide 710-2 includes first portion 711-2, second portion 713-2, and third portion 715-2 analogous to portions 311-2, 313-2 and 315-2 (collectively or generically first portion 711, second portion 713, and third portion 715). Similarly, waveguide 710-1 includes bends 717-1 and 719-1 analogous to bends 317-1 and 319-1, while waveguide 710-2 includes bends 717-2 and 719-2 analogous to bends 317-2 and 319-2 (collectively or generically bends 717 and 719). In some embodiments, electrode(s) 720, 730, and/or 740 carry electrode signal(s) used in modulating the optical signals carried by waveguides 710. TFLC PIC 700 also includes coupling regions 747 and modulation region 749 that are analogous to coupling regions 347 and modulation region 349.

Portions 711 and 713 of waveguides 710 are aligned with modulation region 749. However, portions 711 and 713 of waveguides 710, as well as corresponding coupling regions 747, are vertically aligned with signal electrode 720 (i.e., instead of ground electrodes 730 and 740). Thus, coupling regions 747 are within modulation region 749 in the plan view of FIG. 7. As for coupling regions 347, coupling regions 747 may provide the desired optical losses and the desired gap length without increasing the length of TFLC PIC 700. In addition, the width of TFLC PIC 700 may not be increased by coupling regions 747. Further, TFLC PIC 700 includes additional ground electrodes 731 and 741. Thus, electrodes 720, 730 and 740 may be in a differential configuration. Consequently, modulation of the optical signal in waveguides 310 may be further enhanced. Stated differently, the modulation provided along length Lm and output to waveguide 750 or 752 may be increased.

TFLC PIC 700 may share benefits of TFLC PIC(s) 100, 200, 300, 400, 500, and/or 600. TFLC PIC 700 may have a reduced length while providing desired low loss optical coupling between TFLC waveguides 710 and other waveguides 750 and 752. For lower bending radii, the desired pitch (e.g. width of TFLC PIC 700) may be achieved with the lower optical coupling losses. Other waveguides 750 and 752 may be on TFLC PIC 700, may be on another optical devices such as PIC 701, or otherwise located. Consequently, integration and performance of TFLC PIC 700 may be improved without adversely affecting fabrication (e.g., by reducing the size of the gap, g). TFLC PIC 700 may provide the features such as bit rate per unit length or bit rate per optical fiber described herein. For example, TFLC PIC 700 may be used in or as TFLC PIC 100 and in conjunction with other PIC 701. Use of the differential configuration of electrodes 720, 730, and 740 may further increase the modulation provided. Thus, performance may be improved.

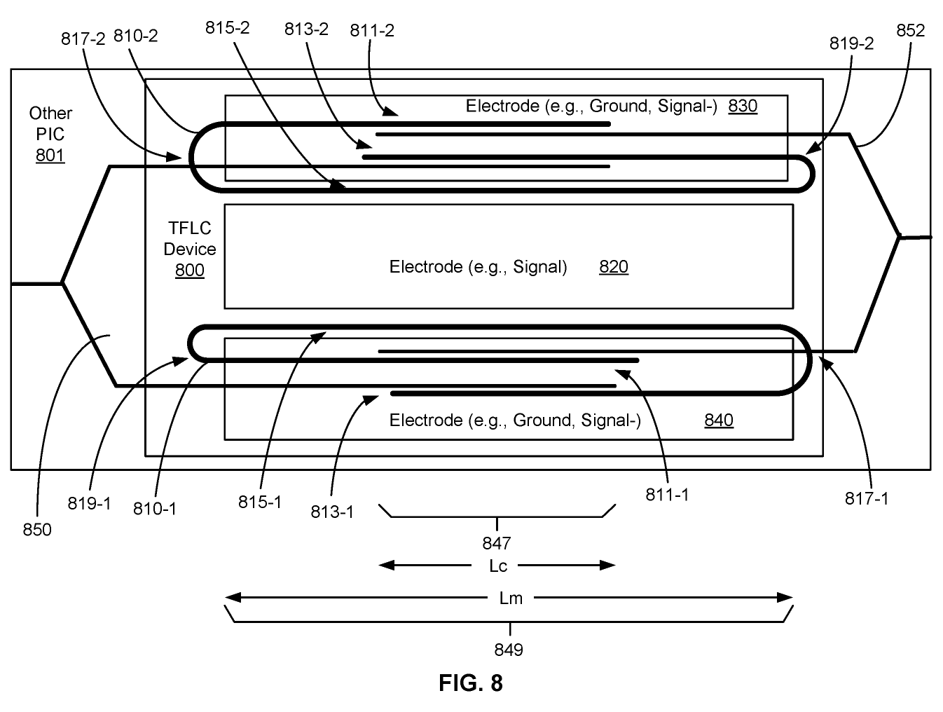

FIG. 8 depicts a plan view of an embodiment of a portion of compact TFLC optical device 800 usable in applications such as data communication. TFLC optical device 800 may be or be part of a TFLC PIC such as TFLC PIC 100. Thus, TFLC optical device 800 is described as a TFLC PIC 800. TFLC PIC 800 is also in the form of an optical modulator analogous to optical modulator 105. However, TFLC PIC 800 may have other and/or additional function(s). Also shown is the environment in which TFLC optical device 800 may be used. Thus, another PIC 801 which includes waveguides 850 and 852 is also shown. For example, PIC 801 may be a SiN or SiP PIC having SiN or Si waveguides 850 and 852.

TFLC PIC 800 is analogous to TFLC PIC(s) 100, 200, 300, 400, 500, 600 and/or 700. Thus, TFLC PIC 800 includes waveguides 810-1 and 810-2 (collectively or generically waveguides 810) and electrodes 820, 830, and 840 that are analogous to waveguides 310-1 and 310-2 and electrodes 320, 330, and 340. Waveguide 810-1 includes first portion 811-1, second portion 813-1, and third portion 815-1 analogous to portions 311-1, 313-1 and 315-1, while waveguide 810-2 includes first portion 811-2, second portion 813-2, and third portion 815-2 analogous to portions 311-2, 313-2 and 315-2 (collectively or generically first portion 811, second portion 813, and third portion 815). Similarly, waveguide 810-1 includes bends 817-1 and 819-1 analogous to bends 317-1 and 319-1, while waveguide 810-2 includes bends 817-2 and 819-2 analogous to bends 317-2 and 319-2 (collectively or generically bends 817 and 819). In some embodiments, electrode(s) 820, 830, and/or 840 carry electrode signal(s) used in modulating the optical signals carried by waveguides 810. TFLC PIC 800 also includes coupling regions 847 and modulation region 849 that are analogous to coupling regions 347 and modulation region 349.

Portions 811 and 813 of waveguides 810 are configured in an analogous manner to portions 311 and 313 of waveguides 310. However, straight portions of waveguides 310 proximate to bends 819-1 are slightly longer. This change in path length may compensate for the optical path difference between the small bends 819 and large bends 817. This may reduce the modulator skew (e.g. to close to 0).

TFLC PIC 800 may share benefits of TFLC PIC(s) 100, 200, 300, 400, 500, 600, and/or 700. TFLC PIC 800 may have a reduced length while providing desired low loss optical coupling between TFLC waveguides 810 and other waveguides 850 and 852. For lower bending radii, the desired pitch (e.g. width of TFLC PIC 800) may be achieved with the lower optical coupling losses. Other waveguides 850 and 852 may be on TFLC PIC 800, may be on another optical devices such as PIC 801, or otherwise located. Consequently, integration and performance of TFLC PIC 800 may be improved without adversely affecting fabrication (e.g., by reducing the size of the gap, g). TFLC PIC 800 may provide the features such as bit rate per unit length or bit rate per optical fiber described herein. For example, TFLC PIC 800 may be used in or as TFLC PIC 100 and in conjunction with other PIC 801. Skew may also be reduced for TFLC PIC 800. Thus, performance may be improved.

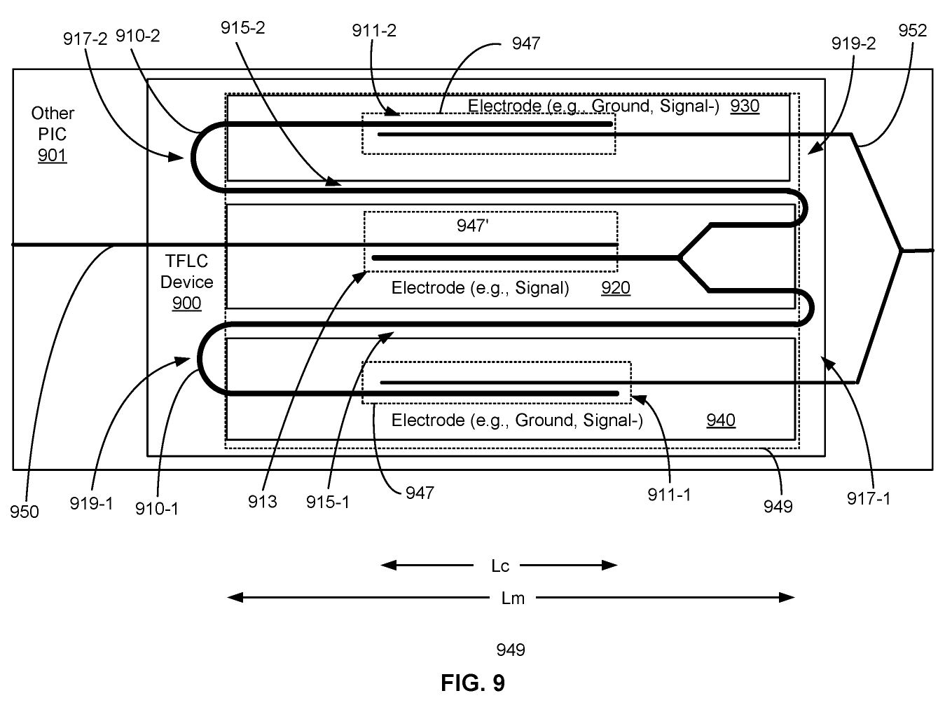

FIG. 9 depicts a plan view of an embodiment of a portion of compact TFLC optical device 900 usable in applications such as data communication. TFLC optical device 900 may be or be part of a TFLC PIC such as TFLC PIC 100. Thus, TFLC optical device 900 is described as a TFLC PIC 900. TFLC PIC 900 is also in the form of an optical modulator analogous to optical modulator 105. However, TFLC PIC 900 may have other and/or additional function(s). Also shown is the environment in which TFLC optical device 900 may be used. Thus, another PIC 901 which includes waveguides 950 and 952 is also shown. For example, PIC 901 may be a SiN or SiP PIC having SiN or Si waveguides 950 and 952.

TFLC PIC 900 is analogous to TFLC PIC(s) 100, 200, 300, 400, 500, 600, 700 and/or 800. Thus, TFLC PIC 900 includes waveguides 910-1 and 910-2 (collectively or generically waveguides 910) and electrodes 920, 930, and 940 that are analogous to waveguides 310-1 and 310-2 and electrodes 320, 330, and 340. Waveguide 910-1 includes first portion 911-1, second portion 913, and third portion 915-1 analogous to portions 311-1, 313-1 and 315-1, while waveguide 910-2 includes first portion 911-2, second portion 913, and third portion 915-2 analogous to portions 311-2, 313-2 and 315-2 (collectively or generically first portion 911, second portion 913, and third portion 915). Similarly, waveguide 910-1 includes bends 917-1 and 919-1 analogous to bends 317-1 and 319-1, while waveguide 910-2 includes bends 917-2 and 919-2 analogous to bends 317-2 and 319-2 (collectively or generically bends 917 and 919). In some embodiments, electrode(s) 920, 930, and/or 940 carry electrode signal(s) used in modulating the optical signals carried by waveguides 910. TFLC PIC 900 also includes coupling regions 947 and modulation region 949 that are analogous to coupling regions 347 and modulation region 349.

Thus, waveguides 910-1 and 910-2 share portion 913. Coupling regions 947 are for waveguide 952, while coupling region 947’ is for waveguide 950 and corresponding portion 913. Thus, fabrication of TFLC PIC 900 may be simplified. In some embodiments, instead of coupling to a waveguide such as waveguide 950, portion 913 may couple to another light source, such as a laser. In such embodiments, a grating or other mechanism may be present at or near portion 913.

TFLC PIC 900 may share benefits of TFLC PIC(s) 100, 200, 300, 400, 500, 600, 700 and/or 800. TFLC PIC 900 may have a reduced length while providing desired low loss optical coupling between TFLC waveguides 910 and other waveguides 950 and 952. For lower bending radii, the desired pitch (e.g. width of TFLC PIC 900) may be achieved with the lower optical coupling losses. Other waveguides 950 and 952 may be on TFLC PIC 900, may be on another optical devices such as PIC 901, or otherwise located. Consequently, integration and performance of TFLC PIC 900 may be improved without adversely affecting fabrication (e.g., by reducing the size of the gap, g). TFLC PIC 900 may provide the features such as bit rate per unit length or bit rate per optical fiber described herein. For example, TFLC PIC 900 may be used in or as TFLC PIC 100 and in conjunction with other PIC 901. Thus, performance may be improved.

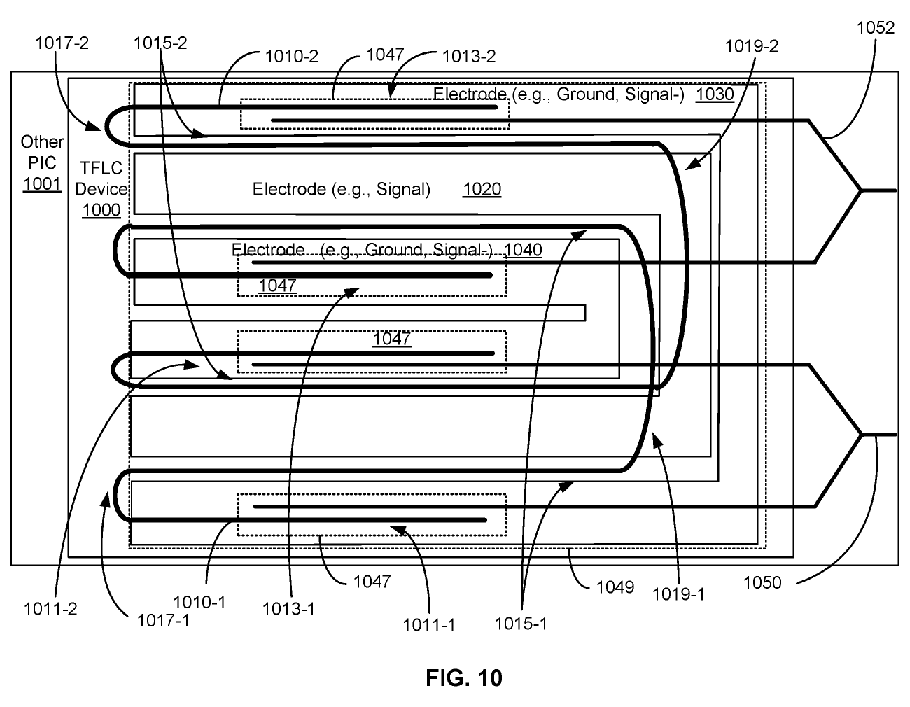

FIG. 10 depicts a plan view of an embodiment of a portion of compact TFLC optical device 1000 usable in applications such as data communication. TFLC optical device 1000 may be or be part of a TFLC PIC such as TFLC PIC 100. Thus, TFLC optical device 1000 is described as a TFLC PIC 1000. TFLC PIC 1000 is also in the form of an optical modulator analogous to optical modulator 105. However, TFLC PIC 1000 may have other and/or additional function(s). Also shown is the environment in which TFLC optical device 1000 may be used. Thus, another PIC 1001 which includes waveguides 1050 and 1052 is also shown. For example, PIC 1001 may be a SiN or SiP PIC having SiN or Si waveguides 1050 and 1052.

TFLC PIC 1000 is analogous to TFLC PIC(s) 100, 200, 300, 400, 500, 600, 700, 800 and/or 900. Thus, TFLC PIC 1000 includes waveguides 1010-1 and 1010-2 (collectively or generically waveguides 1010) and electrodes 1020, 1030, and 1040 that are analogous to waveguides 310-1 and 310-2 and electrodes 320, 330, and 340. Waveguide 1010-1 includes first portion 1011-1, second portion 1013-1, and third portion 1015-1 analogous to portions 311-1, 313-1 and 315-1, while waveguide 1010-2 includes first portion 1011-2, second portion 1013-2, and third portion 1015-2 analogous to portions 311-2, 313-2 and 315-2 (collectively or generically first portion 1011, second portion 1013, and third portion 1015). Similarly, waveguide 1010-1 includes bends 1017-1 and 1019-1 analogous to bends 317-1 and 319-1, while waveguide 1010-2 includes bends 1017-2 and 1019-2 analogous to bends 317-2 and 319-2 (collectively or generically bends 1017 and 1019). In some embodiments, electrode(s) 1020, 1030, and/or 1040 carry electrode signal(s) used in modulating the optical signals carried by waveguides 1010. TFLC PIC 1000 also includes coupling regions 1047 and modulation region 1049 that are analogous to coupling regions 347 and modulation region 349.

Electrodes 1020, 1030, and 1040 may have a U-shaped configuration. In other embodiments, the electrodes may have different configurations. Waveguides 1010-1 and 1010-2 also include additional bends 1019-1 and 1019-2 to account for the configuration of electrodes 10201030, and 1040. In addition, coupling regions 1047 have been split into individual regions for each waveguide 1010-1, 1010-2 and 1050 and 1052. Thus, there are two coupling regions 1047 for waveguide 1010-1 (one for waveguide 1050 and one for waveguide 1052) and two coupling regions for waveguide 1010-2 (one for waveguide 1050 and one for waveguide 1052). The configuration of the waveguides 310 has been adjusted to retain the coupling region(s) 1047 aligned with (e.g. within) modulation region 1047 and aligned with electrodes 1030 and 1040.

TFLC PIC 1000 may share benefits of TFLC PIC(s) 100, 200, 300, 400, 500, 600, 700, 800, and/or 900. TFLC PIC 1000 may have a reduced length while providing desired low loss optical coupling between TFLC waveguides 1010 and other waveguides 1050 and 1052. For lower bending radii, the desired pitch (e.g. width of TFLC PIC 1000) may be achieved with the lower optical coupling losses. Other waveguides 1050 and 1052 may be on TFLC PIC 1000, may be on another optical devices such as PIC 1001, or otherwise located. Consequently, integration and performance of TFLC PIC 1000 may be improved without adversely affecting fabrication (e.g., by reducing the size of the gap, g). TFLC PIC 1000 may provide the features such as bit rate per unit length or bit rate per optical fiber described herein. For example, TFLC PIC 1000 may be used in or as TFLC PIC 100 and in conjunction with other PIC 1001. Thus, performance may be improved.

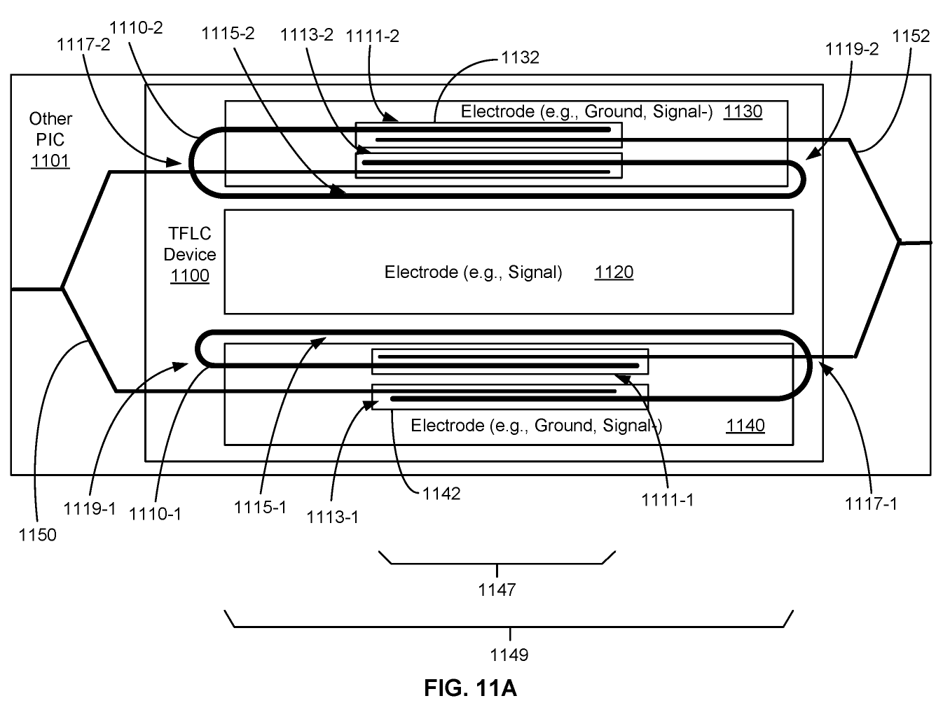

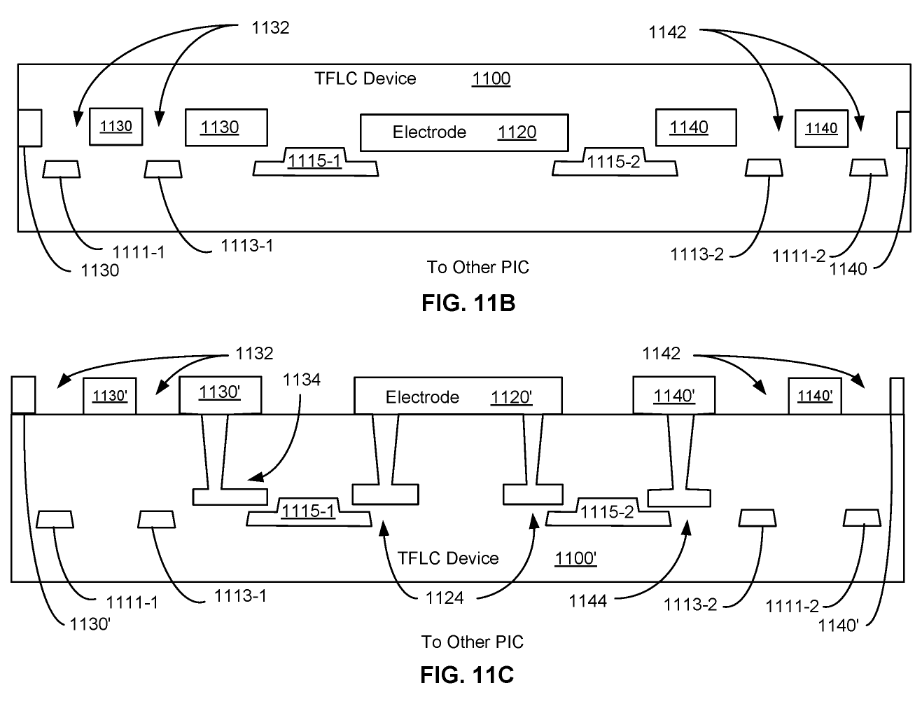

FIGS. 11A-11C depict embodiments of portions of compact TFLC optical devices 1100 and 1100’ usable in applications such as data communication. FIG. 11A depicts a plan view of TFLC PIC 1100. FIG. 11B depicts a cross-sectional view of TFLC PIC 1100. FIG. 11C depicts a cross-sectional view of TFLC PIC 1100’. TFLC optical device(s) 1100 and/or 1100’ may be or be part of a TFLC PIC such as TFLC PIC 100. Thus, TFLC optical device(s) 1100 and/or 1100’ are described as TFLC PICs 1100 and/or 1100’. TFLC PIC(s) 1100 and/or 1100’ are also in the form of an optical modulator analogous to optical modulator 105. However, TFLC PIC(s) 1100 and/or 1100’ may have other and/or additional function(s). Also shown is the environment in which TFLC PIC(s) 1100 and/or 1100’ may be used. Thus, another PIC 1101 which includes waveguides 1150 and 1152 is also shown. For example, PIC 1101 may be a SiN or SiP PIC having SiN or Si waveguides 1150 and 1152.

TFLC PICs 1100 and 1100’ are analogous to TFLC PIC(s) 100, 200, 300, 400, 500, 600, 700, 800, 900, and/or 1000. Thus, TFLC PIC 1100 includes waveguides 1110-1 and 1110-2 (collectively or generically waveguides 1110) and electrodes 1120, 1130, and 1140 that are analogous to waveguides 310-1 and 310-2 and electrodes 320, 330, and 340. Waveguide 1110-1 includes first portion 1111-1, second portion 1113-1, and third portion 1115-1 analogous to portions 311-1, 313-1 and 315-1, while waveguide 1110-2 includes first portion 1111-2, second portion 1113-2, and third portion 1115-2 analogous to portions 311-2, 313-2 and 315-2 (collectively or generically first portion 1111, second portion 1113, and third portion 1115). Similarly, waveguide 1110-1 includes bends 1117-1 and 1119-1 analogous to bends 317-1 and 319-1, while waveguide 1110-2 includes bends 1117-2 and 1119-2 analogous to bends 317-2 and 319-2 (collectively or generically bends 1117 and 1119). In some embodiments, electrode(s) 1120, 1130, and/or 1140 carry electrode signal(s) used in modulating the optical signals carried by waveguides 1110. TFLC PIC 1100 also includes coupling regions 1147 and modulation region 1149 that are analogous to coupling regions 347 and modulation region 349.

Electrodes 1130 and 1140 include apertures 1132 and 1142, respectively. Apertures 1132 and 1142 may reduce optical and/or radio frequency (e.g., microwave or electrode signal) loss if the dielectric layer below electrodes 1130 and/or 1140 has a small gap. For example, the width of apertures may be less than 2 micrometers, less than 3 micrometers, less than 5 micrometers, less than 10 micrometers, less than 15 micrometers and at least 1 micrometer. Further, other structures may be included in electrodes. For example, electrodes 1120’, 1130’ and 1140’ of TFLC PIC 1100’ are analogous to electrodes 1120, 1130 and 1140. Thus, electrodes 1130’ and 1140’ include apertures 1132 and 1142. In addition, electrodes 1120’, 1130’, and 1140’ include extensions 1124, 1134, and 1144 which are close to portions 1115 of waveguides 1110. Thus, modulation of the optical signal in waveguides 1110 may be improved.

TFLC PICs 1100 and/or 1100’ may share benefits of TFLC PIC(s) 100, 200, 300, 400, 500, 600, 700, 800. 900 and/or 1000. TFLC PICs 1100 and/or 1100’ may have a reduced length while providing desired low loss optical coupling between TFLC waveguides 1110 and other waveguides 1150 and 1152. For lower bending radii, the desired pitch (e.g. width of TFLC PICs 1100 and/or 1100’) may be achieved with the lower optical coupling losses. Other waveguides 1150 and 1152 may be on TFLC PIC(s) 1100 and/or 1100’, may be on another optical devices such as PIC 1101, or otherwise located. Consequently, integration and performance of TFLC PIC(s) 1100 and/or 1100’ may be improved without adversely affecting fabrication (e.g., by reducing the size of the gap, g). TFLC PIC(s) 1100 and/or 1100’ may provide the features such as bit rate per unit length or bit rate per optical fiber described herein. For example, TFLC PIC(s) 1100 and/or 1100’ may be used in or as TFLC PIC(s) 1100 and/or 1100’ and in conjunction with other PIC 1101. Thus, performance may be improved.

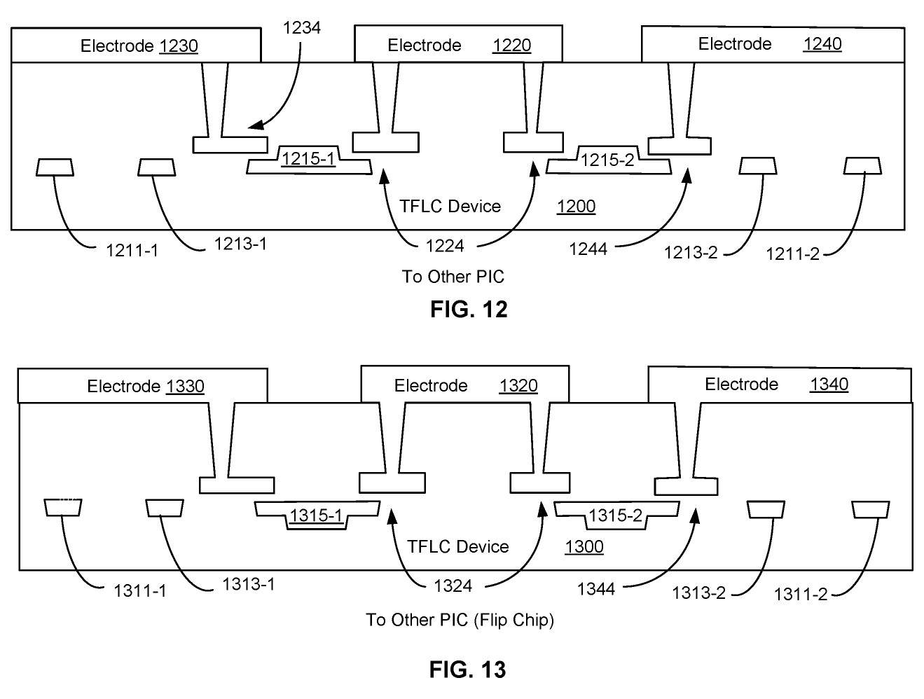

FIG. 12 depicts a cross-sectional view of an embodiment of a portion of compact TFLC optical device 1200 usable in applications such as data communication. TFLC optical device 1200 may be or be part of a TFLC PIC such as TFLC PIC 100. Thus, TFLC optical device 1200 is described as a TFLC PIC 1200. TFLC PIC 1200 is also in the form of an optical modulator analogous to optical modulator 105. However, TFLC PIC 1200 may have other and/or additional function(s). TFLC optical device 1200 may be used with other devices, such as another PIC analogous to PIC 301. Thus, the waveguides analogous to waveguides 350 and 352 may be present but are not shown.

TFLC PIC 1200 is analogous to TFLC PIC(s) 100, 200, 300, 400, 500, 600, 700, 800, 900, 1000, and/or 1100. Thus, TFLC PIC 1200 includes waveguides 1210-1 and 1210-2 (collectively or generically waveguides 1210) and electrodes 1220, 1230, and 1240 that are analogous to waveguides 310-1 and 310-2 and electrodes 320, 330, and 340. Waveguide 1210-1 includes first portion 1211-1, second portion 1213-1, and third portion 1215-1 analogous to portions 311-1, 313-1 and 315-1, while waveguide 1210-2 includes first portion 1211-2, second portion 1213-2, and third portion 1215-2 analogous to portions 311-2, 313-2 and 315-2 (collectively or generically first portion 1211, second portion 1213, and third portion 1215). Similarly, waveguides 1210 includes bends (not shown) analogous to bends 317 and 319. In some embodiments, electrode(s) 1220, 1230, and/or 1240 carry electrode signal(s) used in modulating the optical signals carried by waveguides 1210. TFLC PIC 1200 also includes coupling regions (not labeled) and a modulation region (not labeled) that are analogous to coupling regions 347 and modulation region 349.

Electrodes 1220, 1230, and 1240 include extensions 1224, 1234, and 1244 that are analogous to extensions 224, 234, 1124, 1134, and/or 1144. Further, electrodes 1220, 1230, and 1240 may be configured in ground-signal-ground (GSG), ground-signal-signal-ground (GSSG), ground-signal-ground-signal-ground (GSGSG), signal-signal-signal (SSS), and/or other configurations. For some such configurations, additional electrodes may be provided. Use of extensions 124, 1234 and 1244 may allow the optical path of waveguides 1210 to run underneath the metal, while keeping a gap that is large enough to prevent significant increase in optical propagation loss. For example, the gap between the main metal portion (e.g. a channel region analogous to channel regions 222 and 232) of electrodes 1220, 1230, and 1240 and the top of TFLC waveguides 1210 (e.g. portions 1211, 1213, and 1215) maybe greater than one micrometer, greater than 1.5 micrometer, greater than 2 micrometers, greater than 3 micrometers and/or greater than 5 micrometers and not more than 10 micrometers.

TFLC PIC 1200 may share benefits of TFLC PIC(s) 100, 200, 300, 400, 500, 600, 700, 800, 900, 1000 and/or 1100. TFLC PIC 1200 may have a reduced length while providing desired low loss optical coupling between TFLC waveguides 1210 and other waveguides (not shown). For lower bending radii, the desired pitch (e.g. width of TFLC PIC 1200) may be achieved with the lower optical coupling losses. Other waveguides (not shown) may be on TFLC PIC 1200, may be on other optical device(s), or otherwise located. Consequently, integration and performance of TFLC PIC 1200 may be improved without adversely affecting fabrication (e.g., by reducing the size of the gap, g). TFLC PIC 1200 may provide the features such as bit rate per unit length or bit rate per optical fiber described herein. For example, TFLC PIC 1200 may be used in or as TFLC PIC 100 and in conjunction with other PIC 1201. Thus, performance may be improved.

FIG. 13 depicts a cross-sectional view of an embodiment of a portion of compact TFLC optical device 1300 usable in applications such as data communication. TFLC optical device 1300 may be or be part of a TFLC PIC such as TFLC PIC 100. Thus, TFLC optical device 1300 is described as a TFLC PIC 1300. TFLC PIC 1300 is also in the form of an optical modulator analogous to optical modulator 105. However, TFLC PIC 1300 may have other and/or additional function(s). TFLC optical device 1300 may be used with other devices, such as another PIC analogous to PIC 301. Thus, the waveguides analogous to waveguides 350 and 352 may be present but are not shown.

TFLC PIC 1300 is analogous to TFLC PIC(s) 100, 200, 300, 400, 500, 600, 700, 800, 900, 1000, 1100 and/or 1200. Thus, TFLC PIC 1300 includes waveguides 1310-1 and 1310-2 (collectively or generically waveguides 1310) and electrodes 1320, 1330, and 1340 that are analogous to waveguides 310-1 and 310-2 and electrodes 320, 330, and 340. Waveguide 1310-1 includes first portion 1311-1, second portion 1313-1, and third portion 1315-1 analogous to portions 311-1, 313-1 and 315-1, while waveguide 1310-2 includes first portion 1311-2, second portion 1313-2, and third portion 1315-2 analogous to portions 311-2, 313-2 and 315-2 (collectively or generically first portion 1311, second portion 1313, and third portion 1315). Similarly, waveguides 1310 include bends (not shown) analogous to bends 317 and 319. In some embodiments, electrode(s) 1320, 1330, and/or 1340 carry electrode signal(s) used in modulating the optical signals carried by waveguides 1310. TFLC PIC 1300 also includes coupling regions (not labeled) and a modulation region (not labeled) that are analogous to coupling regions 347 and modulation region 349.

Electrodes 1320, 1330, and 1340 include extensions 1324, 1334, and 1344 that are analogous to extensions 224, 234, 1124, 1134, 1144, 1224, 1234, and/or 1244. Further, electrodes 1320, 1330, and 1340 may be configured in an analogous manner to, for example, electrodes 1220, 1230, and 1240 (e.g. GSG or SSS). In other embodiments, electrodes 1320, 1330, and 1340 may be configured in a different manner. For example, extensions 1324, 1334, and 1344 may be omitted. TFLC PIC 1300 has been prefabricated and prepared for flip-chip bonding. For example, the TFLC optical material may be etched at least twice, forming a double staircase structure in portions 1315 of waveguides 1310. Because TFLC PIC 1300 is flip-chip bonded, the ridge is closer to the bottom of the page in FIG. 13. Thus, electrodes 1320, 1330, and 1340 may be formed after an underlying substrate (not shown) has been removed.

The sidewall angle(s) of and fabrication of waveguides 1310 are analogous to those for other embodiments. For example, the sidewall angles may be less than 90 degrees (e.g., not quite vertical), sometimes less than 85 degrees, sometimes less than 80 degrees, sometimes less than 75 degrees, sometimes less than 70 degrees, and at least 45 degrees, at least 60 degrees, or at least 80 degrees. The smallest feature size in the waveguides 1310 (e.g. the ridge in regions 1315 or regions 1311 or 1313) may be at most 1 micrometer, at most 500 nm, at most 200 nm and at least 50 nm. In some embodiments, the thickness of TFLC layer from which waveguides 1310 are fabricated may be up to 300 nm or more, at least 350 nm, up to 400 nm or more, up to 500 nm or more, up to 600 nm or more, up to 700 nm or more, up to 1 micrometer or more, up to 1.5 micrometer or more, 2 micrometer, and/or less than 2 micrometer. In some embodiments, a first etch may be at least 20% of TFLC layer thickness, sometimes up to 30% of TFLC layer thickness, sometimes up to 40% of TFLC layer thickness, sometimes up to 50% of TFLC layer thickness, sometimes up to 70% of TFLC layer thickness. The total dielectric thickness to the etch of the TFLC layer may be, e.g. 1 to 0.5, where the dielectric thickness is provided on the etched TFLC layer. In some embodiments, the modulation (e.g. through the modulation region) may have optical losses of less than 5 dB, less than 3 dB, less than 1 dB, or less than 0.5 dB.

Light from a single source (e.g. a continuous wave light source) may be shared between the dielectric of the TFLC PIC 1300 and the PIC with which TFLC PIC 1300 is to be bonded. The coupling between two waveguides (TFLC waveguides 1310 and other structures/waveguide via portions 1311 and/or 1313) may be evanescent coupling, coupling through gratings, coupling through edge coupling, or made in another matter. The bonding between TFLC PIC 1300 and the other PIC may occur at the lower surface of TFLC PIC in FIG. 13. The dielectric used in the other PIC may be the same as or different from the dielectric (e.g., cladding) for TFLC PIC 1300. The distance between bond (e.g. lower) interface to the waveguides 1310 may be at least 100 nm, 200 nm, 500 nm, 1 micrometer.

TFLC PIC 1300 may share benefits of TFLC PIC(s) 100, 200, 300, 400, 500, 600, 700, 800, 900, 1000, 1100 and/or 1200. TFLC PIC 1300 may have a reduced length while providing desired low loss optical coupling between TFLC waveguides 1310 and other waveguides (not shown). For lower bending radii, the desired pitch (e.g. width of TFLC PIC 1300) may be achieved with the lower optical coupling losses. Other waveguides (not shown) may be on TFLC PIC 1300, may be on other optical device(s), or otherwise located. Consequently, integration and performance of TFLC PIC 1300 may be improved without adversely affecting fabrication (e.g., by reducing the size of the gap, g). TFLC PIC 1300 may provide the features such as bit rate per unit length or bit rate per optical fiber described herein. For example, TFLC PIC 1300 may be used in or as TFLC PIC 100 and in conjunction with other PIC 1301. Thus, performance may be improved.

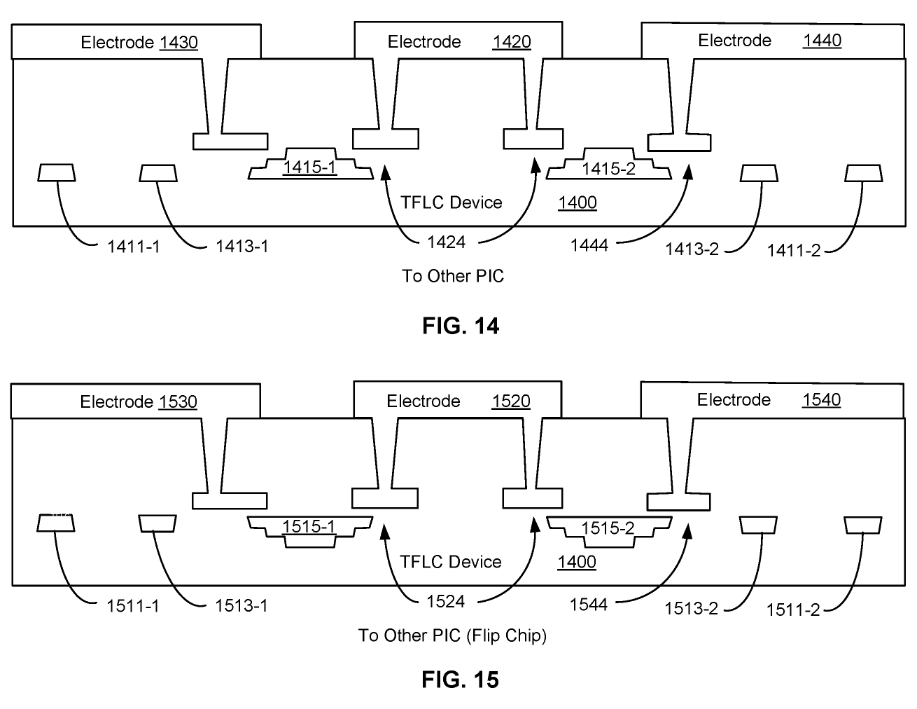

FIG. 14 depicts a cross-sectional view of an embodiment of a portion of compact TFLC optical device 1400 usable in applications such as data communication. TFLC optical device 1400 may be or be part of a TFLC PIC such as TFLC PIC 100. Thus, TFLC optical device 1400 is described as a TFLC PIC 1400. TFLC PIC 1400 is also in the form of an optical modulator analogous to optical modulator 105. However, TFLC PIC 1400 may have other and/or additional function(s). TFLC optical device 1400 may be used with other devices, such as another PIC analogous to PIC 301. Thus, the waveguides analogous to waveguides 350 and 352 may be present but are not shown.

TFLC PIC 1400 is analogous to TFLC PIC(s) 100, 200, 300, 400, 500, 600, 700, 800, 900, 1000, 1100, 1200 and/or 1300. Thus, TFLC PIC 1400 includes waveguides 1410-1 and 1410-2 (collectively or generically waveguides 1410) and electrodes 1420, 1430, and 1440 that are analogous to waveguides 310-1 and 310-2 and electrodes 320, 330, and 340. Waveguide 1410-1 includes first portion 1411-1, second portion 1413-1, and third portion 1415-1 analogous to portions 311-1, 313-1 and 315-1, while waveguide 1410-2 includes first portion 1411-2, second portion 1413-2, and third portion 1415-2 analogous to portions 311-2, 313-2 and 315-2 (collectively or generically first portion 1411, second portion 1413, and third portion 1415). Similarly, waveguides 1410 include bends (not shown) analogous to bends 317 and 319. In some embodiments, electrode(s) 1420, 1430, and/or 1440 carry electrode signal(s) used in modulating the optical signals carried by waveguides 1410. TFLC PIC 1400 also includes coupling regions (not labeled) and a modulation region (not labeled) that are analogous to coupling regions 347 and modulation region 349.

Electrodes 1420, 1430, and 1440 include extensions 1424, 1434, and 1444 that are analogous to extensions 224, 234, 1124, 1134, 1144, 1224, 1234, and/or 1244. Further, electrodes 1420, 1430, and 1440 may be configured in an analogous manner to, for example, electrodes 1220, 1230, and 1240 (e.g. GSG or SSS). Fabrication of waveguides 1410 is analogous to waveguides of other embodiments. However, at least two etches of the TFLC layer forming waveguides 1410 have been performed. Thus, portions 1415 of waveguides 1410 have a double ridge structure (e.g. three layers instead of two—a ridge and a slab) indicated. In some embodiments, dielectric may be between two or more of the layers of portions 1415 of waveguides 1410. Although shown as having only one layer, in some embodiments, portions 1411 and/or 1413 of waveguides 1410 may have multiple layers. The transition between the number of layers (e.g. between the configurations of portions 1411 and 1413 and portion 1415 of waveguides 14100 may occur before or after the bends (not shown). Further, the layer(s) of TFLC waveguides 1410 may have dielectric between one or more of the layers. In such embodiments, for example, portions 1411 and/or 1413 of the TFLC waveguide in the coupling region may have a different location vertically than in other regions. Thus, configuration of waveguides 1410 may provide additional control over the optical signal carried by waveguides 1410.

TFLC PIC 1400 may share benefits of TFLC PIC(s) 100, 200, 300, 400, 500, 600, 700, 800, 900, 1000 and/or 1100. TFLC PIC 1400 may have a reduced length while providing desired low loss optical coupling between TFLC waveguides 1410 and other waveguides (not shown). For lower bending radii, the desired pitch (e.g. width of TFLC PIC 1400) may be achieved with the lower optical coupling losses. Other waveguides (not shown) may be on TFLC PIC 1400, may be on another optical devices, or otherwise located. Consequently, integration and performance of TFLC PIC 1400 may be improved without adversely affecting fabrication (e.g., by reducing the size of the gap, g). TFLC PIC 1400 may provide the features such as bit rate per unit length or bit rate per optical fiber described herein. For example, TFLC PIC 1400 may be used in or as TFLC PIC 100 and in conjunction with other PIC 1401. Thus, performance may be improved.

FIG. 15 depicts a cross-sectional view of an embodiment of a portion of compact TFLC optical device 1500 usable in applications such as data communication. TFLC optical device 1500 may be or be part of a TFLC PIC such as TFLC PIC 100. Thus, TFLC optical device 1500 is described as a TFLC PIC 1500. TFLC PIC 1500 is also in the form of an optical modulator analogous to optical modulator 105. However, TFLC PIC 1500 may have other and/or additional function(s). TFLC optical device 1500 may be used with other devices, such as another PIC analogous to PIC 301. Thus, the waveguides analogous to waveguides 350 and 352 may be present but are not shown.

TFLC PIC 1500 is analogous to TFLC PIC(s) 100, 200, 300, 400, 500, 600, 700, 800, 900, 1000, 1100, 1200, 1300 and/or 1430. Thus, TFLC PIC 1500 includes waveguides 1510-1 and 1510-2 (collectively or generically waveguides 1510) and electrodes 1520, 1530, and 1540 that are analogous to waveguides 310-1 and 310-2 and electrodes 320, 330, and 340. Waveguide 1510-1 includes first portion 1511-1, second portion 1513-1, and third portion 1515-1 analogous to portions 311-1, 313-1 and 315-1, while waveguide 1510-2 includes first portion 1511-2, second portion 1513-2, and third portion 1515-2 analogous to portions 311-2, 313-2 and 315-2 (collectively or generically first portion 1511, second portion 1513, and third portion 1515). Similarly, waveguides 1510 includes bends (not shown) analogous to bends 317 and 319. In some embodiments, electrode(s) 1520, 1530, and/or 1540 carry electrode signal(s) used in modulating the optical signals carried by waveguides 1510. TFLC PIC 1500 also includes coupling regions (not labeled) and a modulation region (not labeled) that are analogous to coupling regions 347 and modulation region 349.

Electrodes 1520, 1530, and 1540 include extensions 1524, 1534, and 1544 that are analogous to extensions 224, 234, 1124, 1134, 1144, 1224, 1234, and/or 1244. Further, electrodes 1520, 1530, and 1540 may be configured in an analogous manner to, for example, electrodes 1220, 1230, and 1240 (e.g. GSG or SSS). In some embodiments, electrodes 1520, 1530, and/or 1540 may be configured in a different manner. For example, extensions 1524, 1534, and/or 1534 may be omitted. Fabrication of waveguides 1510 is analogous to waveguides of other embodiments. However, at least two etches of the TFLC layer forming waveguides 1510 have been performed. Fabrication of waveguides 1510 may, therefore, be most analogous to that of waveguides 1410. Thus, portions 1515 of waveguides 1510 have a double ridge structure (e.g. three layers instead of two—a ridge and a slab) indicated. In addition, TFLC PIC 1500 has been prepared for flip-chip bonding. Because TFLC PIC 1400 is to be flip-chip bonded, the ridge(s) (the layers having a smaller width) are closer to the bottom of the page in FIG. 15. Thus, electrodes 1520, 1530, and 1540 may be formed after an underlying substrate (not shown) has been removed.

TFLC PIC 1500 may share benefits of TFLC PIC(s) 100, 200, 300, 400, 500, 600, 700, 800, 900, 1000 and/or 1100. TFLC PIC 1500 may have a reduced length while providing desired low loss optical coupling between TFLC waveguides 1510 and other waveguides (not shown). For lower bending radii, the desired pitch (e.g. width of TFLC PIC 1500) may be achieved with the lower optical coupling losses. Other waveguides (not shown) may be on TFLC PIC 1500, may be on other optical device(s), or otherwise located. Consequently, integration and performance of TFLC PIC 1500 may be improved without adversely affecting fabrication (e.g., by reducing the size of the gap, g). TFLC PIC 1500 may provide the features such as bit rate per unit length or bit rate per optical fiber described herein. For example, TFLC PIC 1500 may be used in or as TFLC PIC 100 and in conjunction with other PIC 1501. Thus, performance may be improved.

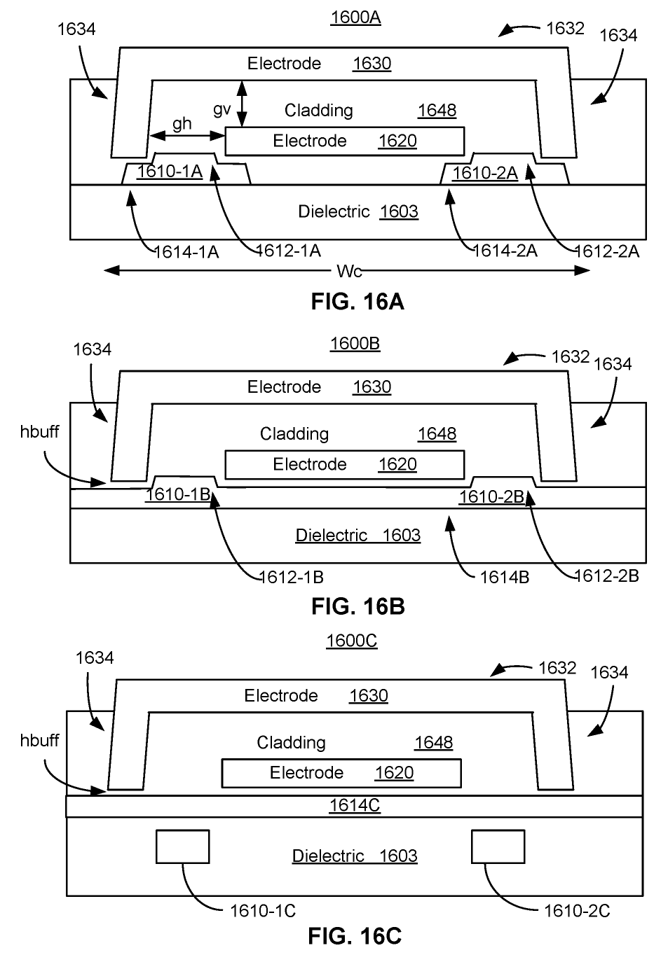

Thus, TFLC PICs 300, 400, 500, 600, 700, 800, 900, 1100, 1100’, 1200, 1300, 1400, and/or 1500 may have a compact length, for example due to the configuration of their coupling regions. Although various configurations have been shown, features may be mixed and/or matched in other manners. FIGS. 16A-27 depict embodiments of TFLC PICs which may allow for a reduced pitch between waveguides and/or optical modulators (e.g., channels). The features shown in FIGS. 16A-27 may be combined with those shown in FIGS. 1 through 27. Thus, configurations not explicitly described herein may be provided.

FIGS. 16A-16C depict cross-sectional views of embodiments of portions of compact TFLC optical devices 1600A, 1600B, and 1600C usable in applications such as data communication. FIGS. 16A, 16B, and 16C depict a cross-sectional view of the modulation regions of TFLC PICs 1600A, 1600B, and 1600C. TFLC optical devices 1600A, 1600B, and/or 1600C may be or be part of a TFLC PIC such as TFLC PIC 100. Thus, TFLC optical devices 1600A, 1600B, and/or 1600C are described as TFLC PIC(s) 1600A, 1600B, and/or 1600C. TFLC PIC(s) 1600A, 1600B, and/or 1600C are also in the form of optical modulators analogous to optical modulator 105. In some embodiments, TFLC PIC(s) 1600A, 1600B, and/or 1600C may have other and/or additional functions. Thus, multiple modulators, each of which corresponds to the portion of TFLC PIC(s) 1600A, 1600B, and/or 1600C shown, may be present. Further, if in a Mach-Zehnder configuration, a cross-sectional view of only the arms of the optical modulator of TFLC PICs 1600A, 1600B, and/or 1600C are shown. In some embodiments, two adjacent channels (e.g., the optical modulator shown and another optical modulator including waveguides adjacent to waveguides 1610) may be configured to carry counter-propagating signals.

Referring to FIG. 16A, TFLC PIC 1600A includes waveguides 1610-1A and 1610-2A (collectively or generically waveguides 1610A) and electrodes 1620 and 1630. In some embodiments, waveguides 1610A include or consist of TFLC optical material(s), such as TFLN and/or TFLT. Waveguides 1610A are analogous to waveguide 210 and/or waveguides 310 (and analogous waveguides described herein). Thus, waveguide 1610-1A includes ridge 1612-1A and slab 1614-1A, while waveguide 1610-2A each includes ridge 1612-2A and slab 1614-2A (collective or generally ridge 1612A and/or slab 1614A). In some embodiments, waveguides 1610A may have another configuration. In some embodiments, the width of top ridges 1612A may be less than 10 micrometer, less than 5 micrometers, less than 3 micrometers, less than 2.5 micrometer, or less than 1.5 micrometer. Other widths are possible. In some embodiments, the height of TFLC waveguides 1610A is less than 2 micrometers, less than 1 micrometer, not more than 700 nanometers, not more than 600 nanometers, not more than 500 nanometers, or not more than 400 nanometers. Other heights are possible. In some embodiments, the width of slab portion 1614A may be less than 10 micrometers, less than 5 micrometers, less than 3 micrometers, less than 2.5 micrometers, or less than 1.5 micrometer and, in some embodiments, more than 0.5 micrometers. Other widths are possible.

In some embodiments, electrodes 1620 and 1630 are analogous to electrodes 220, 230, and 240, and/or electrodes 320, 330, and 340 (and/or other electrodes described herein). Electrode(s) 1620 and/or thus 1630 carry electrode signal(s) used in modulating the optical signals carried by waveguides 1610A. For example, electrodes 1620 and 1630 may each carry signals (e.g. differential signals), electrode 1620 may carry an electrode signal while electrode 1630 is ground, or electrode 1630 may carry an electrode signal while electrode 1620 is ground. Electrodes 1620 and 1630 may, therefore, support a single-ended or a differential configuration (e.g. signal/signal-, or S/S- where S- has opposite polarity to S). In other embodiments, electrodes 1620 and 1630 may be configured differently.

Electrode 1620 is between waveguides 1610-1A and 1610-2A. In some embodiments, electrode 1620 may have a simplified shape. For example, electrode 1620 may have a rectangular footprint. In other embodiments, electrode 1620 may have additional structures. For example, electrode 1620 may include extensions analogous to extensions 222 and 224, and/or other extensions (e.g. extensions 1424 and/or 1434) described herein. Electrode 1630 has a central, channel region 1632 and extended portions 1634. In some embodiments, extended portions 1634 are solid regions. Thus, the plan view of electrode 1630 may indicate a rectangular footprint. In such embodiments, the electrode current may flow throughout electrode 1630. In some embodiments, extended portions 1634 may be extensions which have a pitch and are spaced apart along the direction of transmission of the electrode signal in electrode 1630. In such embodiments, the electrode current may flow primarily through channel region 1632.

Waveguides 1610A are between a portion (e.g. the ends) of electrode 1620 and a portion (e.g., extended regions 1634) of electrode 1630. Thus, in operation, an electric field that modulates the optical signals in waveguides 1610A may be generated by electrode signal(s) carried by electrodes 1620 and/or 1630. In some embodiments, the electric field generated has a substantial component in-plane in the regions of waveguides 1610A.

A second portion (e.g., central, channel region 1632) of the electrode 1630 and a second portion (e.g., the central region or the entirety of) electrode 1620 are aligned and offset vertically. Stated differently, electrode 1620 and some or all of electrode 1630 (e.g., channel region 1632) are offset in a direction perpendicular-to-plane for TFLC PIC 1600A. The center of electrode 1620 and the center of electrode 1630 (e.g., the center of channel region 1632) are aligned along a direction perpendicular-to-plane (e.g. perpendicular to the surface of dielectric 1603). Thus, at least part of electrodes 1620 and 1630 are aligned and vertically offset. In some embodiments, electrodes 1620 and 1630 may also be offset in a direction in-plane. For example, the center of electrode 1620 may be shifted horizontally from the center of electrode 1630/channel region 1632. Thus, in contrast to TFLC PIC 200, electrodes 1620 and 1630 are arranged vertically instead of horizontally. Stated differently, portions of electrodes 1620 and 1630 may be offset vertically (perpendicular-to-plane) instead of substantially in-plane. Although not shown, ground electrodes may be present.

In some embodiments, the vertical gap, gv, between the electrodes 1620 and 1630 (e.g. to channel region 1632) may be at least 1 micrometer, at least 2 micrometers, at least 3 micrometers or at least 5 micrometers. The horizontal gap gh may be at least 1.5 micrometers, at least 2.5 micrometers, at least 3.5 micrometers, at least 5 micrometers, or at least 7 micrometers and not more than 15 micrometers. In some embodiments, the width of electrode 1620 may be not more than 100 micrometers, not more than 50 micrometers, not more than 30 micrometers, not more than 15 micrometers, not more than 10 micrometers, or not more than 5 micrometers and at least one micrometer. In some embodiments, electrode 1630 has a width of at least 3 micrometers, at least 5 micrometers, or at least 10 micrometers wider than electrode 1620.

TFLC PIC 1600A may support efficient electro-optic modulation and high bandwidth density. The vertical transmission line structure of electrodes 1620 and 1630 may reduce the width, Wc, of the optical modulator of TFLC PIC 1600A. The pitch of optical modulators for a TFLC PIC 1600A including multiple modulators may thus be reduced. In some embodiments, the modulator is also shortened (e.g. using a coupling region aligned with the modulation region). Shorter modulators may reduce the velocity matching issues between the electrode (microwave/RF signal) in electrode(s) 1620 and/or 1630 and the optical signal in waveguides 1610, may reduce RF losses and may reduce cross-talk between modulators.

In some embodiments, the EO modulation efficiency (e.g., V-pi-L) for TFLC PIC 1600A is better than 2 V-cm, better (less) than 1.8 V-cm, better than 1.6 V-cm, better than 1.4 V cm, better than 1.2 V-cm or better than 1 V-cm. The length (perpendicular to the page in FIG. 16A) of the modulator of TFLC PIC 1600A may be less than 10 millimeters, less than 5 millimeters, less than 4 millimeters, less than 3 millimeters, or less than 2 mm and greater than 0.5 mm millimeters in some embodiments. The optical insertion loss on the modulator for TFLC PIC 1600A may be better (less) than 5 dB, less than 3 dB, less than 2 dB or less than 1 dB in various embodiments. For example, the electro-optic modulator of TFLC PIC 1600A may have an electro-optic bandwidth of at least 50 GHz, 70 GHz, 100 GHz, 130 GHz, 140GHz, 150 GHz, 200 GHz, or 220 GHz. Thus, TFLC PIC 1600A may provide performance characteristics desired for optical modulators 105 of TFLC PIC 100.

FIG. 16B depicts TFLC PIC 1600B. TFLC PIC 1600B is analogous to TFLC PIC 1600A. Thus, electrodes 1620 and 1630 (including extended regions 1634) are analogous to electrodes 1620 and 1630 of TFLC PIC 1600A. TFLC PIC 1600B also includes waveguides 1610-1B and 1610-2B (collectively or generically waveguides 1610B) that are analogous to waveguides 1610A. Thus, waveguides 1610-1B and 1610-2B include ridge portions 1612-1B and 1612-2B that are analogous to ridges 1610-1A and 1610-2. However, waveguides 1610 include a continuous slab region 1614B. Extended portions 1634 are separated from slab 1614B by dielectric buffer layer hbuff. The dielectric buffer layer hbuff may be 0 nanometers thick (i.e., extended portions 1634 contact slab 1614B), not more than 100 nanometers thick, not more than 300 nanometers thick, not more than 1 micrometer thick, or not more than 1.5 micrometer thick.

FIG. 16C depicts TFLC PIC 1600C. TFLC PIC 1600B is analogous to TFLC PIC(s) 1600A and/or 1600B. Thus, electrodes 1620 and 1630 (including extended regions 1634) are analogous to electrodes 1620 and 1630 of TFLC PIC 1600A. TFLC PIC 1600B also includes waveguides 1610-1C and 1610-2C (collectively or generically waveguides 1610C) that are analogous to waveguides 1610A and 1610B. However, waveguides 1610C may be formed of another material, such as SiN. In the embodiment shown, TFLC slab 1614C is between waveguides 1610C and electrodes 1620 and 1630. TFLC slab portion 1614C may be continuous. In addition, extended portions 1634 may be separated from slab portion 1614C by dielectric buffer layer hbuff having the thicknesses described for TFLC PIC 1600B.

TFLC PICs 1600A, 1600B, and/or 1600C may have improved performance. Electrodes 1630 and 1620 are vertically offset. Consequently, the optical modulators of TFLC PIC(s) 1600A, 1600B, and/or 1600C may have a smaller width, Wc, than an optical modulator having the electrodes horizontally offset (e.g. as for electrodes 220 and 230). The pitch of multiple optical modulators for TFLC PICs 1600A, 1600B, and/or 1600C may be reduced. In some embodiments, the pitch for TFLC PICs 1600A, 1600B, and/or 1600C may be in the ranges described for optical modulators 105. For example, the pitch may be not more than one hundred and thirty micrometers. Thus, the bit rate per modulator and thus per unit width of TFLC PICs 1600A, 1600B, and/or 1600C may be increased. The bit rates per unit length (or per optical fiber) may be in the range described for TFLC PIC 100. For example, in some embodiments, TFLC PICs 1600A, 1600B, and/or 1600C may be configured to support optical signals corresponding to transmission of at least 700 Gb/s per millimeter of width of TFLC PICs 1600A, 1600B, and/or 1600C and/or transmission of at least 800 Gb/s per optical fiber. Each optical modulator for TFLC PICs 1600A, 1600B, and/or 1600C may have the desired optical performance described herein. For example, the optical modulator of TFLC PICs 1600A, 1600B, and/or 1600C may have an electro-optic bandwidth of at least 120 GHz, a crosstalk with another of the optical modulators of less than thirty dB, a V-pi of at least 5 V, an optical loss of not more than 1 dB through an optical modulator and/or a length of at least 0.5 millimeter and not more than five millimeters. Thus, TFLC PICs 1600A, 1600B, and/or 1600C may support a higher bit rate per unit length of the width of TFLC PICs 1600A, 1600B, and/or 1600C while having reduced losses and the desired optical performance. Particularly when combined with coupling regions which are aligned with the modulation regions, the length of TFLC PICs 1600A, 1600B, and/or 1600C may also be reduced. Thus, higher density integration may be possible.

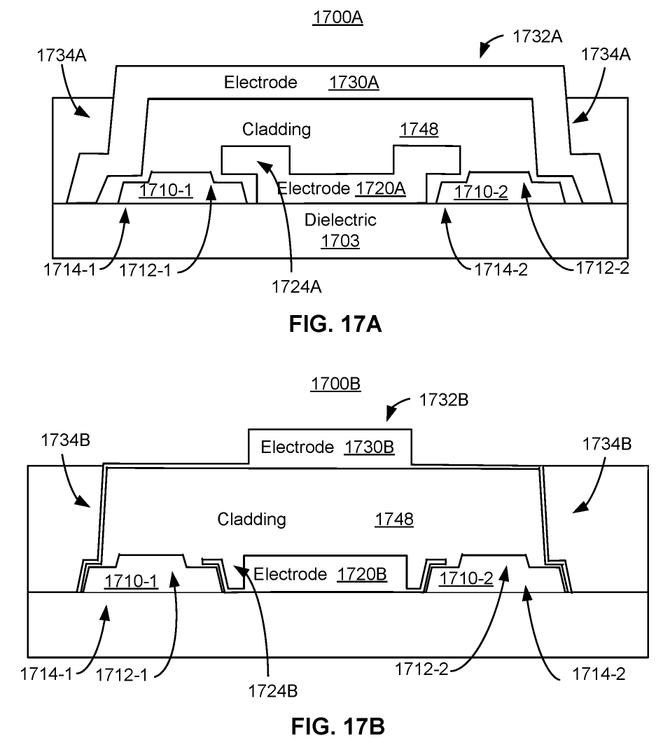

FIGS. 17A-17B depict cross-sectional views of embodiments of portions of compact TFLC optical devices 1700A and 1700B usable in applications such as data communication. FIGS. 17A and 17B depict a cross-sectional view of the modulation regions of TFLC optical devices 1700A and 1700B. TFLC optical devices 1700A and/or 1700B may be or be part of a TFLC PIC such as TFLC PIC 100. Thus, TFLC optical devices 1700A and/or 1700B are described as TFLC PIC(s) 1700A and/or 1700B. TFLC PIC(s) 1700A and/or 1700B are also in the form of optical modulators analogous to optical modulator 105. In some embodiments, TFLC PIC(s) 1700A and/or 1700B may have other and/or additional functions. Thus, multiple modulators, each of which corresponds to the portion of 1700A and/or 1700B shown, may be present. Further, if in a Mach-Zehnder configuration, a cross-sectional view of only the arms of the optical modulator of TFLC PICs 1700A and/or 1700B are shown. In some embodiments, two adjacent channels (e.g., the optical modulator shown and an optical modulator including waveguides adjacent to waveguides 1710A and/or 1710B) may be configured to carry counter-propagating signals.

TFLC PICS 1700A and 1700B are analogous to TFLC PICs 1600A, 1600B, and 1600C. Referring to FIG. 17A, TFLC PIC 1700A includes waveguides 1710-1 and 1710-2 (collectively or generically waveguides 1710) and electrodes 1720A and 1730A that are analogous to waveguides 1610 and electrodes 1620 and 1630. Waveguide 1710-1 includes ridge 1712-1 and slab 1714-1, while waveguide 1710-21710-1 includes ridge 1712-2 and slab 1714-2 (collectively or generically ridge 1712 and slab 1714). Electrodes 1720A and 1730A are vertically offset in an analogous manner to electrodes 1620 and 1630. Electrodes 1730A and 1720A include central, channel regions 1732 and 1732, respectively. Electrode 1730A includes extended portions 1734A that extend to and are conformal with the sidewalls of waveguides 1710. Electrode 1720A also includes extended portions 1724A that extend past the sidewalls of waveguides 1710. In some embodiments, extended portions 1724A and 1734A are solid. Thus, electrodes 1730A and 1720A may have a rectangular footprint. Extended regions 1724A and 1734A may partially surround waveguides 1710. Thus, modulation of the optical signal in waveguides 1710 may be improved. Moreover, waveguides 1710 may be partially or fully etched to provide additional surface area. Thus, extended portions 1724A and 1734A may be placed in proximity to a larger portion of waveguides 1710 and modulation improved.

Referring to FIG. 17B, TFLC PIC 1700B includes waveguides 1710-1 and 1710-2 (collectively or generically waveguides 1710) and electrodes 1720B and 1730B that are analogous to waveguides 1610 and 1710 and electrodes 1620 and 1630. Waveguide 1710-1 includes ridge 1712-1 and slab 1714-1, while waveguide 1710-21710-1 includes ridge 1712-2 and slab 1714-2 (collectively or generically ridge 1712 and slab 1714). Electrodes 1720B and 1730B are vertically offset in an analogous manner to electrodes 1620 and 1630. Electrode 1730B includes extensions 1734B that extend to and are conformal with the sidewalls of waveguides 1710. Electrode 1720B also includes extensions 1724B that extend past the sidewalls of waveguides 1710. In some embodiments, extensions 1724B and 1734B are separated in the direction perpendicular to the page and may have a pitch. Extensions 1724B and 1734B are also analogous to extended portions 1724A and 1734A. Extensions 1724B and 1734B may partially surround waveguides 1710. Thus, modulation of the optical signal in waveguides 1710 may be improved. Moreover, waveguides 1710 may be partially or fully etched to provide additional surface area. Thus, extended portions 1724A and 1734A may be placed in proximity to a larger portion of waveguides 1710 and modulation improved.

TFLC PICs 1700A and/or 1700B may share the benefits of TFLC PICs 1600A, 1600B, and/or 1600C. Electrodes 1730A and 1720A and electrodes 1730B and 1720B are vertically offset. Consequently, the optical modulators of TFLC PIC(s) 1700A and/or 1700B may have a smaller width than an optical modulator having the electrodes horizontally offset (e.g. as for electrodes 220 and 230). The pitch of multiple optical modulators for TFLC PICs 1700A and/or 1700B may be reduced. In some embodiments, the pitch for TFLC PICs 1700A and/or 1700B may be in the ranges described for optical modulators 105. Thus, the bit rate per modulator, the bit rate per unit width of TFLC PICs 1700A and/or 1700B, and/or the bit rate per optical fiber may be increased. Performance of individual optical modulators in TFLC PICs 1700A and/or 1700B may also be improved. Particularly when combined with coupling regions which are aligned with the modulation regions, the length of TFLC PICs 1700A and/or 1700B may also be reduced. Thus, higher density integration may be possible.

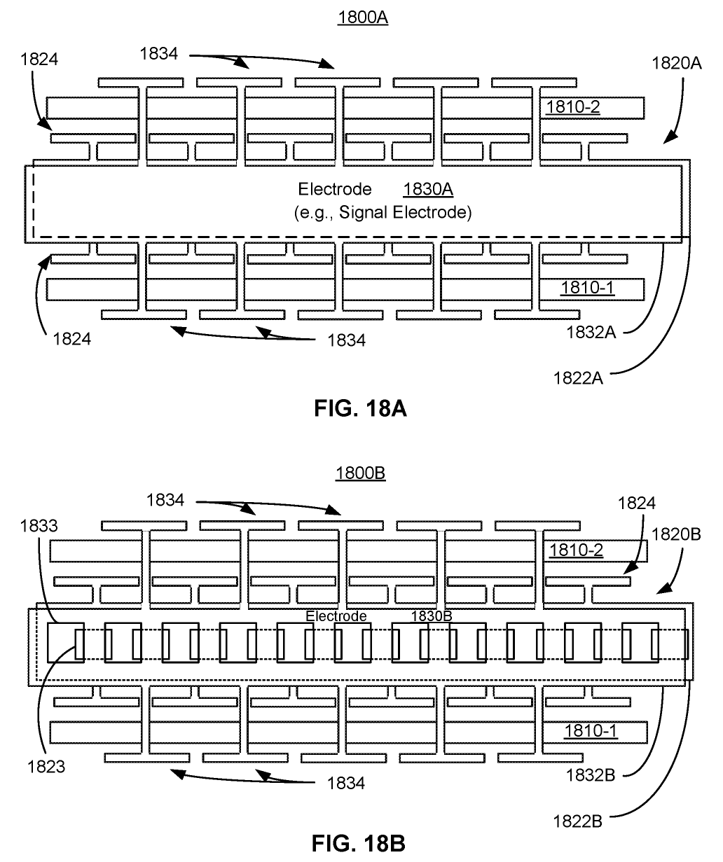

FIGS. 18A-18B depict plan views of embodiments of portions of compact TFLC optical devices 1800A and 1800B usable in applications such as data communication. TFLC optical devices 1800A and/or 1800B may be or be part of a TFLC PIC such as TFLC PIC 100. Thus, TFLC optical devices 1800A and/or 1800B are described as TFLC PIC(s) 1800A and/or 1800B. TFLC PIC(s) 1800A and/or 1800B are also in the form of optical modulators analogous to optical modulator 105. In some embodiments, TFLC PIC(s) 1800A and/or 1800B may have other and/or additional functions. Thus, multiple modulators, each of which corresponds to the portion of 1800A and/or 1800B shown, may be present. Further, if in a Mach-Zehnder configuration, a cross-sectional view of only the arms of the optical modulator of TFLC PICs 1800A and/or 1800B are shown. In some embodiments, two adjacent channels may be configured to carry counter-propagating signals.

TFLC PICS 1800A and 1800B are analogous to TFLC PICs 1600A, 1600B, and 1600C. Referring to FIG. 18A, TFLC PIC 1800A includes waveguides 1810-1 and 1810-2 (collectively or generically waveguides 1810) and electrodes 1820A and 1830A that are analogous to waveguides 1610 and electrodes 1620 and 1630. Electrode 1830A includes channel region 1832A and extensions 1834. Similarly, electrode 1820A includes channel region 1822A and extensions 1834. Extensions 1824 and 1834 are configured in an analogous manner to extensions 224 and 234. Extensions 1824 and 1834 may help to reduce RF loss, improve velocity matching and tailor (e.g. increase) the impedance of electrodes 1820A and 1830A. Extensions 1824 and 1834 may partially surround waveguides 1810. Electrodes 1820A and 1830A are vertically offset in an analogous manner to electrodes 1620 and 1630. More specifically, channel regions 1822A and 1832A are aligned and vertically offset. Thus, the pitch of optical modulators for TFLC PIC 1800A may be reduced. Thus, modulation of the optical signal in waveguides 1810 may be improved.

Referring to FIG. 18B, TFLC PIC 1800B includes waveguides 1810-1 and 1810-2 (collectively or generically waveguides 1810) and electrodes 1820B and 1830B that are analogous to waveguides 1610 and electrodes 1620 and 1630. Electrodes 1820B and 1830B are vertically offset in an analogous manner to electrodes 1620 and 1630. Electrodes 1820B and 1830B include extensions 1824 that are analogous to extensions 224 and 234. Extensions 1824 and 1834 may help to reduce RF loss, improve velocity matching and tailor (e.g. increase) the impedance of electrodes 1820B and 1830B. Extensions 1824 and 1834 may partially surround waveguides 1810. Thus, modulation of the optical signal in waveguides 1810 may be improved. Electrodes 1820B and 1830B are vertically offset in an analogous manner to electrodes 1620 and 1630. More specifically, channel regions 1822B and 1832B are aligned and vertically offset. Thus, the pitch of optical modulators for TFLC PIC 1800A may be reduced.

Channel regions 1822B and 1832B also include apertures 1823 and 1833 therein. In some embodiments, only channel region 1822B includes apertures 1823. In some embodiments, only channel region 1832B includes apertures 1833. In some embodiments (e.g., in TFLC PIC 1800B) both channel regions 1822B and 1832B also include apertures 1823 and 1833 Apertures 1823 and 1833 may be used to tailor the impedance of the electrodes.

TFLC PICs 1800A and/or 1800B may share the benefits of TFLC PICs 1600A, 1600B, and/or 1600C. Electrodes 1830A and 1820A and electrodes 1830B and 1820B are vertically offset. Consequently, the optical modulators of TFLC PIC(s) 1800A and/or 1800B may have a smaller width than an optical modulator having the electrodes horizontally offset (e.g. as for electrodes 220 and 230). The pitch of multiple optical modulators for TFLC PICs 1800A and/or 1800B may be reduced. In some embodiments, the pitch for TFLC PICs 1800A and/or 1800B may be in the ranges described for optical modulators 105. Thus, the bit rate per modulator, the bit rate per unit width of TFLC PICs 1800A and/or 1800B, and/or the bit rate per optical fiber may be increased. Performance of individual optical modulators in TFLC PICs 1800A and/or 1800B may also be improved. Particularly when combined with coupling regions which are aligned with the modulation regions, the length of TFLC PICs 1800A and/or 1800B may also be reduced. Thus, higher density integration may be possible.

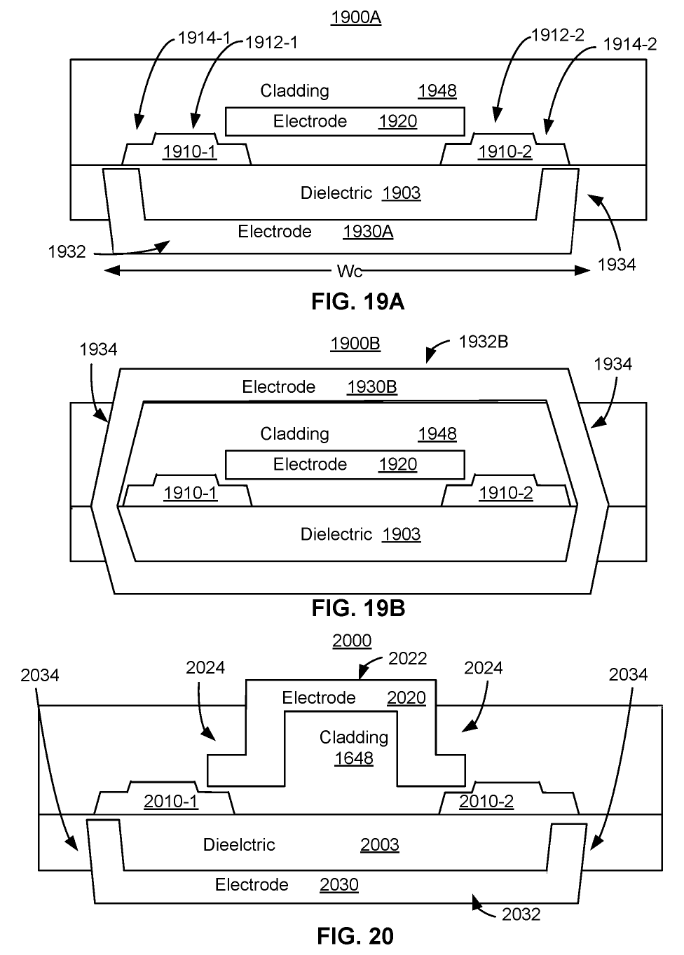

FIGS. 19A-19B depict cross-sectional views of embodiments of portions of compact TFLC optical devices 1900A and 1900B usable in applications such as data communication. TFLC optical devices 1900A and/or 1900B may be or be part of a TFLC PIC such as TFLC PIC 100. Thus, TFLC optical devices 1900A and/or 1900B are described as TFLC PIC(s) 1900A and/or 1900B. TFLC PIC(s) 1900A and/or 1900B are also in the form of optical modulators analogous to optical modulator 105. In some embodiments, TFLC PIC(s) 1900A and/or 1900B may have other and/or additional functions. Thus, multiple modulators, each of which corresponds to the portion of 1900A and/or 1900B shown, may be present. Further, in a Mach-Zehnder configuration, a cross-sectional view of only the arms of the optical modulator of TFLC PICs 1900A and/or 1900B are shown. In some embodiments, two adjacent channels may be configured to carry counter-propagating signals.

TFLC PICS 1900A and 1900B are analogous to TFLC PICs 1600A, 1600B, and 1600C. Referring to FIG. 19A, TFLC PIC 1900A includes waveguides 1910-1 and 1910-2 (collectively or generically waveguides 1910) and electrodes 1920 and 1930A that are analogous to waveguides 1610 and electrodes 1620 and 1630. Electrode 1930A includes channel region 1932A and extended portions 1934. Although shown as solid, extended portions 1934 may be configured as extensions that may have a separation and pitch. Extended portions 1934 may help to reduce RF loss, improve velocity matching and tailor (e.g. increase) the impedance of electrode 1930A. Electrodes 1920 and 1930A are vertically offset in an analogous manner to electrodes 1620 and 1630. More specifically, electrode 1920 and channel region 1932A are aligned and vertically offset. However, electrode 1930A is on the opposite side (e.g., under) waveguides 1910. This structure 1930A may be fabricated through, for example, flip-chip bonded wafers. The distance between electrodes 1920 and 1930A may be greater than 1 micrometer, greater than 2 micrometers, greater than 3 micrometers, greater than 5 micrometers and may be less than 20 micrometers. Thus, the pitch of optical modulators for TFLC PIC 1900A may be reduced. Thus, modulation of the optical signal in waveguides 1910 may be improved.

Referring to FIG. 19B, TFLC PIC 1900B includes waveguides 1910-1 and 1910-2 (collectively or generically waveguides 1910) and electrodes 1920 and 1930B that are analogous to waveguides 1610 and electrodes 1620 and 1630. Electrodes 1920 and 1930B are vertically offset in an analogous manner to electrodes 1620 and 1630. Electrode 1930B includes extended portions 1934. Although depicted as solid extended portions 1934, extensions may be used instead. Extended portions 1934 may help to reduce RF loss, improve velocity matching and tailor (e.g. increase) the impedance of electrodes 1920B and 1930B. In addition, extended portions 1934 reach around to under waveguides 1910. Electrode 1930B substantially surrounds waveguides 1910. Thus, modulation of the optical signal in waveguides 1910 may be improved. The use of electrode 1930B that may be substantially surrounding the TFLC waveguide(s) may improve shielding between optical modulators and/or confine the electric field from the electrode signal to the optical modulator.

TFLC PICs 1900A and/or 1900B may share the benefits of TFLC PICs 1600A, 1600B, and/or 1600C. Electrodes 1930A and 1920 and electrodes 1930B and 1920 are vertically offset. Consequently, the optical modulators of TFLC PIC(s) 1900A and/or 1900B may have a smaller width than an optical modulator having the electrodes horizontally offset (e.g. as for electrodes 220 and 230). The pitch of multiple optical modulators for TFLC PICs 1900A and/or 1900B may be reduced. In some embodiments, the pitch for TFLC PICs 1900A and/or 1900B may be in the ranges described for optical modulators 105. Thus, the bit rate per modulator, the bit rate per unit width of TFLC PICs 1900A and/or 1900B, and/or the bit rate per optical fiber may be increased. Performance of individual optical modulators in TFLC PICs 1900A and/or 1900B may also be improved. Particularly when combined with coupling regions which are aligned with the modulation regions, the length of TFLC PICs 1900A and/or 1900B may also be reduced. Thus, higher density integration may be possible. In addition, use of extended regions 1934 which partially or fully surround waveguides 1910 may improve performance.

FIG. 20 depicts a cross-sectional view of an embodiment of portions of compact TFLC optical device 2000 usable in applications such as data communication. TFLC optical device 2000 may be or be part of a TFLC PIC such as TFLC PIC 100. Thus, TFLC optical device 2000is described as a TFLC PIC 2000. TFLC PIC 2000 is also in the form of optical modulators analogous to optical modulator 105. In some embodiments, TFLC PIC 2000 may have other and/or additional functions. Thus, multiple modulators, each of which corresponds to the portion of 2000 shown, may be present. Further, for a Mach-Zehnder configuration, a cross-sectional view of only the arms of the optical modulator of TFLC PICs 2000A and/or 2000B are shown. In some embodiments, two adjacent channels may be configured to carry counter-propagating signals.

TFLC PIC 2000 is analogous to TFLC PICs 1600A, 1600B, and 1600C. Referring to FIG. 20, TFLC PIC 2000 includes waveguides 2010-1 and 2010-2 (collectively or generically waveguides 2010) and electrodes 2020 and 2030 that are analogous to waveguides 1610 and electrodes 1620 and 1630. Electrode 2030 includes channel region 2032 and extended portions 2034. Although shown as solid, extended portions 2034 may be configured as extensions that may have a separation and pitch. Electrode 2020 includes channel region 2022 and extended portions 2024. Although shown as solid, extended portions 2024 may be configured as extensions that may have a separation and pitch. Extended portions 2024 and 2034 may help to reduce RF loss, improve velocity matching and tailor (e.g. increase) the impedance of electrodes 2020 and/or 2030. Electrodes 2020 and 2030 are vertically offset in an analogous manner to electrodes 1620 and 1630. More specifically, electrode 2020 and channel region 2032A are aligned and vertically offset. Thus, the pitch of optical modulators for TFLC PIC 2000 may be reduced. Thus, modulation of the optical signal in waveguides 2010 may be improved.

In addition, channel region 2022 of electrode 2020 is raised/further from waveguides 2010. This configuration increases the distance between channel region 2022 and channel region 230. The impedance of the transmission line 2020 may thus be increased, which is generally desirable. The larger distance between channel regions 2022 and 2032 may be greater than 1 micrometer, greater than 2 micrometers, or greater than 5 micrometers.

TFLC PIC 2000 may share the benefits of TFLC PICs 1600A, 1600B, and/or 1600C. Electrodes 2030 and 2020 are vertically offset. Consequently, the optical modulators of TFLC PIC 2000 may have a smaller width than an optical modulator having the electrodes horizontally offset. The pitch of multiple optical modulators for TFLC PIC 2000 may be reduced. In some embodiments, the pitch for TFLC PIC 2000 may be in the ranges described for optical modulators 105. Thus, the bit rate per modulator, the bit rate per unit width of TFLC PIC 2000, and/or the bit rate per optical fiber may be increased. Performance of individual optical modulators in TFLC PIC 2000 may also be improved. Particularly when combined with coupling regions which are aligned with the modulation regions, the length of TFLC PICs PIC 2000 may also be reduced. Thus, higher density integration may be possible.

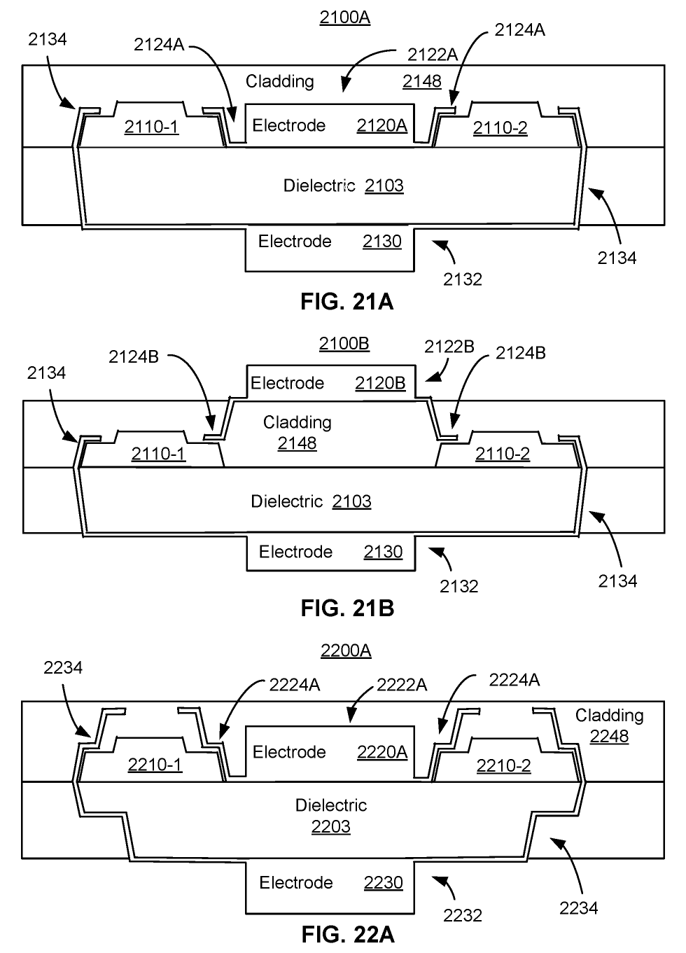

FIGS. 21A-21B depict cross-sectional views of embodiments of portions of compact TFLC optical devices 2100A and 2100B usable in applications such as data communication. TFLC optical devices 2100A and/or 2100B may be or be part of a TFLC PIC such as TFLC PIC 100. Thus, TFLC optical devices 2100A and/or 2100B are described as TFLC PIC(s) 2100A and/or 2100B. TFLC PIC(s) 2100A and/or 2100B are also in the form of optical modulators analogous to optical modulator 105. In some embodiments, TFLC PIC(s) 2100A and/or 2100B may have other and/or additional functions. Thus, multiple modulators, each of which corresponds to the portion of 2100A and/or 2100B shown, may be present. Further, if in a Mach-Zehnder configuration, a cross-sectional view of only the arms of the optical modulator of TFLC PICs 2100A and/or 2100B are shown. In some embodiments, two adjacent channels may be configured to carry counter-propagating signals.

TFLC PICS 2100A and 2100B are analogous to TFLC PICs 1600A, 1600B, and 1600C. Referring to FIG. 21A, TFLC PIC 2100A includes waveguides 2110-1 and 2110-2 (collectively or generically waveguides 2110) and electrodes 2120A and 2130 that are analogous to waveguides 1610 and electrodes 1620 and 1630. Electrode 2130 includes channel region 2132 and extensions 2134. Electrode 2120A includes channel region 2122A and extensions 2124A. Extensions 2124A and 2134 may help to reduce RF loss, improve velocity matching and tailor (e.g. increase) the impedance of electrodes 2120A and 2130. Electrodes 2120A and 2130 are vertically offset in an analogous manner to electrodes 1620 and 1630. More specifically, channel region 2122A and channel region 2132 are aligned and vertically offset. Thus, the pitch of optical modulators for TFLC PIC 2100A may be reduced. Thus, modulation of the optical signal in waveguides 2110 may be improved.

Referring to FIG. 21B, TFLC PIC 2100B is analogous to TFLC PIC 2100A. However, channel region 2122B of electrode 2120B is further from channel region 2132 than channel region 2122A is. This configuration increases the distance between channel region 2122B and channel region 2132. The impedance of the transmission line 2120B may thus be increased, which is generally desirable. The larger distance between channel regions 2022 and 2032 may be greater than 1 micrometer, greater than 2 micrometers, or greater than 5 micrometers.

TFLC PICs 2100A and/or 2100B may share the benefits of TFLC PICs 1600A, 1600B, and/or 1600C. Electrodes 2130 and 2120A and electrodes 2130 and 2120B are vertically offset. Consequently, the optical modulators of TFLC PIC(s) 2100A and/or 2100B may have a smaller width than an optical modulator having the electrodes horizontally offset. The pitch of multiple optical modulators for TFLC PICs 2100A and/or 2100B may be reduced. In some embodiments, the pitch for TFLC PICs 2100A and/or 2100B may be in the ranges described for optical modulators 105. Thus, the bit rate per modulator, the bit rate per unit width of TFLC PICs 2100A and/or 2100B, and/or the bit rate per optical fiber may be increased. Performance of individual optical modulators in TFLC PICs 2100A and/or 2100B may also be improved. Particularly when combined with coupling regions which are aligned with the modulation regions, the length of TFLC PICs 2100A and/or 2100B may also be reduced. Thus, higher density integration may be possible. In addition, use of extended regions 2134 which partially or fully surround waveguides 2110 may improve performance.

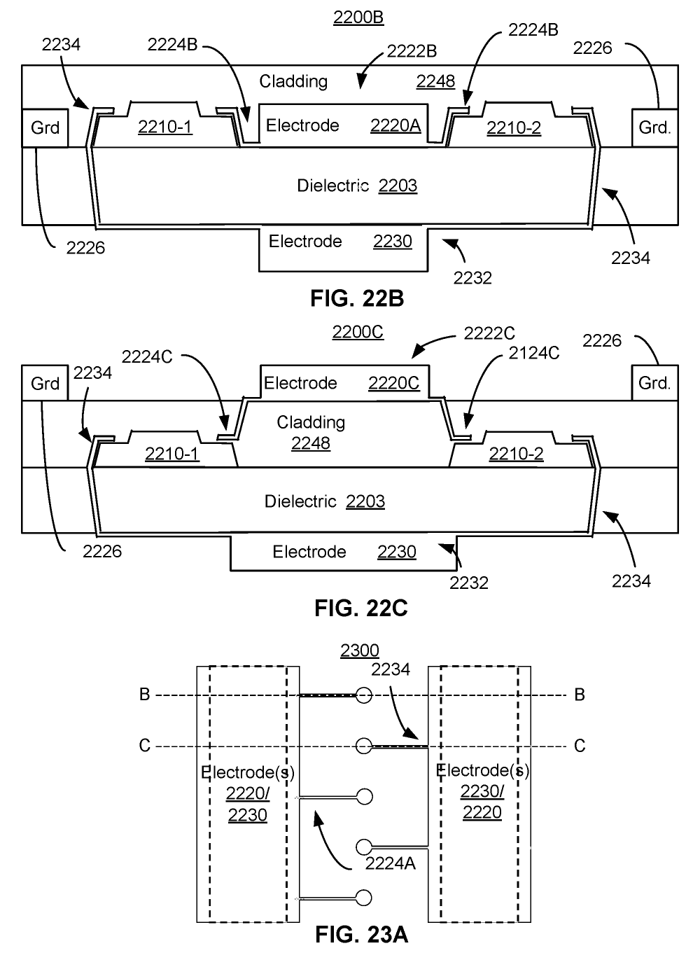

FIGS. 22A-22C depict cross-sectional views of embodiments of portions of compact TFLC optical devices 2200A, 2200B and 2200C usable in applications such as data communication. TFLC optical devices 2200A, 2200B and/or 2200C may be or be part of a TFLC PIC such as TFLC PIC 100. Thus, TFLC optical devices 2200A, 2200B and/or 2200C are described as TFLC PIC(s) 2200A, 2200B and/or 2200C. TFLC PIC(s) 2200A, 2200B and/or 2200C are also in the form of optical modulators analogous to optical modulator 105. In some embodiments, TFLC PIC(s) 2200A, 2200B and/or 2200C may have other and/or additional functions. Thus, multiple modulators, each of which corresponds to the portion of 2200A, 2200B and/or 2200C shown, may be present. Further, if in a Mach-Zehnder configuration, a cross-sectional view of only the arms of the optical modulator of TFLC PICs 2200A, 2200B and/or 2200C are shown. In some embodiments, two adjacent channels may be configured to carry counter-propagating signals.

TFLC PICS 2200A, 2200B and/or 2200C are analogous to TFLC PICs 1600A, 1600B, and 1600C. Referring to FIG. 22A, TFLC PIC 2200A includes waveguides 2210-1 and 2210-2 (collectively or generically waveguides 2210) and electrodes 2220A and 2230 that are analogous to waveguides 1610 and electrodes 1620 and 1630. Electrode 2230 includes channel region 2232 and extensions 2234. Electrode 2220A includes channel region 2222A and extensions 2224A. Extensions 2224A and 2234 may help to reduce RF loss, improve velocity matching and tailor (e.g. increase) the impedance of electrodes 22020A and 2230. Extensions 2224A and 2234 may also extend further above and better surround waveguides 2210. Electrodes 2220A and 2230 are vertically offset in an analogous manner to electrodes 1620 and 1630. More specifically, channel region 2222A and channel region 2232 are aligned and vertically offset. Thus, the pitch of optical modulators for TFLC PIC 2200A may be reduced. Thus, modulation of the optical signal in waveguides 2210 may be improved.

Referring to FIG. 22B, TFLC PIC 2200B is analogous to TFLC PIC 2200A. TFLC PIC 2200b includes waveguides 2210-1 and 2210-2 (collectively or generically waveguides 2210) and electrodes 2220B and 2230 that are analogous to waveguides 2210 and electrodes 2220A and 2230. However, extensions 2234 and 2224B do not extend as far above waveguides 2210. Thus, fabrication may be simplified. In addition, ground electrodes 2226 and 2236 are provided. Additional ground electrodes 2226 and 2236 may provide further mode management and shielding.

Referring to FIG. 22C, TFLC PIC 2200C is analogous to TFLC PIC(s) 2200A and/or 2200B. However, channel region 2222C of electrode 2220C is further from channel region 2232 than channel region 2222B is. This configuration increases the distance between channel region 2222C and channel region 2232. The impedance of the transmission line 2220C may thus be increased, which is generally desirable. The larger distance between channel regions 2022C and 2032 may be greater than 1 micrometer, greater than 2 micrometers, or greater than 5 micrometers. In addition, ground electrodes 2226 and 2236 are provided. Additional ground electrodes 2226 and 2236 may provide for a more balanced GSSG configuration of electrodes 2220C, 2230, 2226, and 2236. To maintain the balance between signal lines 2220C and 2230 (e.g. S and S-), the vertical position of the ground electrodes 2226 and 2236 and the lateral size of the signal lines 2220C and 2230 may be adjusted. In TFLC PIC 2200C, ground electrodes 2226 and 2236 are placed closer to the top to maintain a (more) equal capacitance for electrodes 2220C and 2230. The lateral width of channel 2232 may be larger than channel region 2220C to compensate for the additional inductance introduced by the longer segment path.

TFLC PICs 2200A, 2200B and/or 2200C may share the benefits of TFLC PICs 1600A, 1600B, and/or 1600C. Electrodes 2220A, 2220B, and 2220C are vertically offset from electrodes 2230. Consequently, the optical modulators of TFLC PIC(s) 2200A, 2200B and/or 2200C may have a smaller width than an optical modulator having the electrodes horizontally offset. The pitch of multiple optical modulators for TFLC 2200A, 2200B and/or 2200C may be reduced. In some embodiments, the pitch for TFLC PICs 2200A, 2200B and/or 2200C may be in the ranges described for optical modulators 105. Thus, the bit rate per modulator, the bit rate per unit width of TFLC PICs 2200A, 2200B and/or 2200C, and/or the bit rate per optical fiber may be increased. Performance of individual optical modulators in TFLC PICs 2200A, 2200B and/or 2200C may also be improved. Particularly when combined with coupling regions which are aligned with the modulation regions, the length of TFLC PICs 2200A, 2200B and/or 2200C may also be reduced. Thus, higher density integration may be possible.

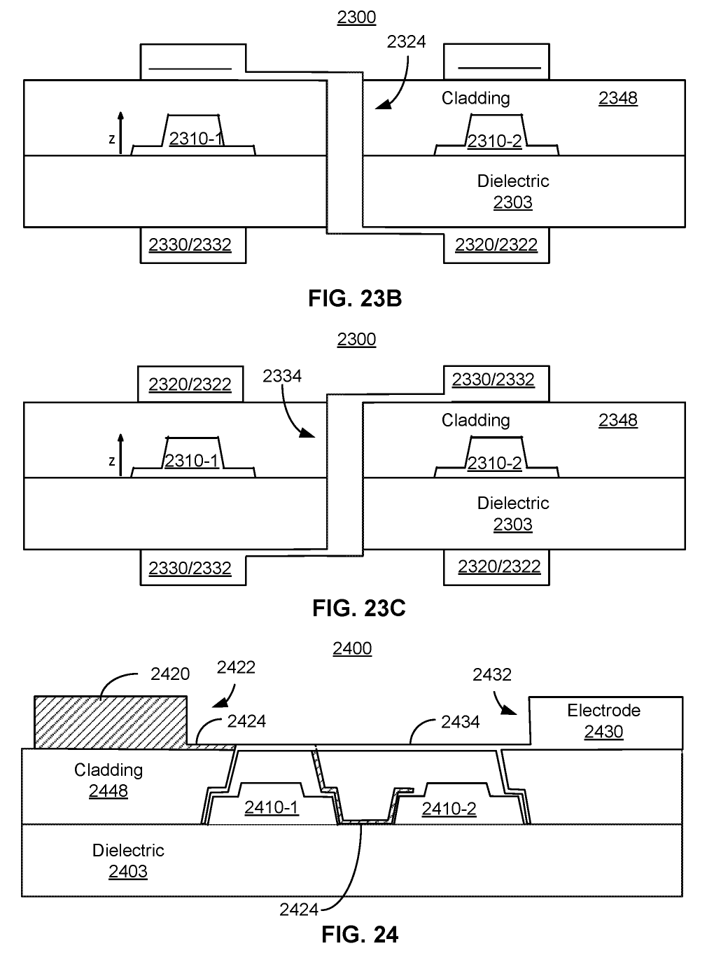

FIGS. 23A-23C depict an embodiment of portions of compact TFLC optical device 2300 usable in applications such as data communication. FIG. 23A depicts a plan view of TFLC optical device 2300. FIGS. 23B and 23C depict cross-sectional view along lines B-B and C-C shown in FIG. 23A. TFLC optical device 2300 may be or be part of a TFLC PIC such as TFLC PIC 100. Thus, TFLC optical device 2300 is described as a TFLC PIC 2300. TFLC PIC 2300 is also in the form of optical modulators analogous to optical modulator 105. In some embodiments, TFLC PIC 2300 may have other and/or additional functions. Thus, multiple modulators, each of which corresponds to the portion of PIC 2300 shown, may be present. Further, if in a Mach-Zehnder configuration, a cross-sectional view of only the arms of the optical modulator of TFLC PIC 2300 are shown. In some embodiments, two adjacent channels may be configured to carry counter-propagating signals.

TFLC PIC 2300 is analogous to TFLC PICs 1600A, 1600B, and 1600C. TFLC PIC 2300 includes waveguides 2310-1 and 2310-2 (collectively or generically waveguides 2310) and electrodes 2320A and 2330 that are analogous to waveguides 1610 and electrodes 1620 and 1630. However, waveguides 2310 may be formed from or include z-cut TFLC optical material(s) (e.g., z-cut TFLN and/or z-cut TFLT). In the embodiment shown, the z-axis of the TFLC material(s) of waveguides 2310 is perpendicular to plane. In this embodiment, the TM modes in waveguides 2310 are guided. This electrode layout scheme also works for other TFLC materials (e.g. other cuts of TFLC materials). Electrode 2330 includes channel region 2332 and extensions 2334. Electrode 2320 includes channel region 2322 and extensions 2324. Extensions 2324 extend from channel region 2322 near the top of TFLC PIC 2300, across TFLC PIC 2300 to a channel region 2322 below a portion of electrode 2330. Similarly, extensions 2334 extend from channel region 2332 near the top of TFLC PIC 2300, across TFLC PIC 2300 to a channel region 2332 below a portion of electrode 2320. Thus, portions of electrodes 2320 and 2330 are vertically offset in an analogous manner to electrodes 1620 and 1630. More specifically, channel region 2322 and channel region 2332 are aligned and vertically offset. Thus, the pitch of optical modulators for TFLC PIC 2300A may be reduced. Thus, modulation of the optical signal in z-cut waveguides 2310 may be improved.

TFLC PIC 2300 may share the benefits of TFLC PICs 1600A, 1600B, and/or 1600C. Portions of electrode 2320 are vertically offset from portions of electrode 2330. Consequently, the optical modulators of TFLC PIC 2300 may have a smaller width than an optical modulator having the electrodes horizontally offset. The pitch of multiple optical modulators for PIC 2300 may be reduced. In some embodiments, the pitch for TFLC PIC 2300 may be in the ranges described for optical modulators 105. Thus, the bit rate per modulator, the bit rate per unit width of TFLC PIC 2300, and/or the bit rate per optical fiber may be increased. Performance of individual optical modulators in TFLC PIC 2300 may also be improved. Particularly when combined with coupling regions which are aligned with the modulation regions, the length of TFLC PIC 2300 may also be reduced. Thus, higher density integration may be possible. Moreover, different cuts of TFLC electro-optic materials may be used for waveguides 2310.

FIG. 24 depicts a cross-sectional view of an embodiment of portions of compact TFLC optical device 2400 usable in applications such as data communication. TFLC optical device 2400 may be or be part of a TFLC PIC such as TFLC PIC 100. Thus, TFLC optical device 2400 is described as a TFLC PIC 2400. TFLC PIC 2400 is also in the form of optical modulators analogous to optical modulator 105. In some embodiments, TFLC PIC 2400 may have other and/or additional functions. Thus, multiple modulators, each of which corresponds to the portion of PIC 2400 shown, may be present. Further, if in a Mach-Zehnder configuration, a cross-sectional view of only the arms of the optical modulator of TFLC PIC 2400 is shown. In some embodiments, two adjacent channels may be configured to carry counter-propagating signals.

TFLC PIC 2400 is analogous to TFLC PICs 1600A, 1600B, and 1600C. TFLC PIC 2400 includes waveguides 2410-1 and 2410-2 (collectively or generically waveguides 2410) and electrodes 2420A and 2430 that are analogous to waveguides 1610 and electrodes 1620 and 1630. Electrode 2430 includes channel region 2432 and extensions 2434. Electrode 2420 includes channel region 2422 and extensions 2424. Channel regions 2422 and 2432 are horizontally offset (rather than vertically offset). However, extensions 2424 and 2434 are interleaved and offset. Further, extensions 2424 and 2434 extend vertically toward waveguides 2410. Thus, each electrode 2420 and 2430 provides extensions for both waveguides. Consequently, the width of TFLC PIC 2400 may still be reduced.

TFLC PIC 2400 may share the benefits of TFLC PICs 1600A, 1600B, and/or 1600C. The optical modulators of TFLC PIC 2400 may have a more compact width. The pitch of multiple optical modulators for PIC 2400 may be reduced. In some embodiments, the pitch for TFLC PIC 2400 may be in the ranges described for optical modulators 105. Thus, the bit rate per modulator, the bit rate per unit width of TFLC PIC 2400, and/or the bit rate per optical fiber may be increased. Performance of individual optical modulators in TFLC PIC 2400 may also be improved. Particularly when combined with coupling regions which are aligned with the modulation regions, the length of TFLC PIC 2400 may also be reduced. Thus, higher density integration may be possible.

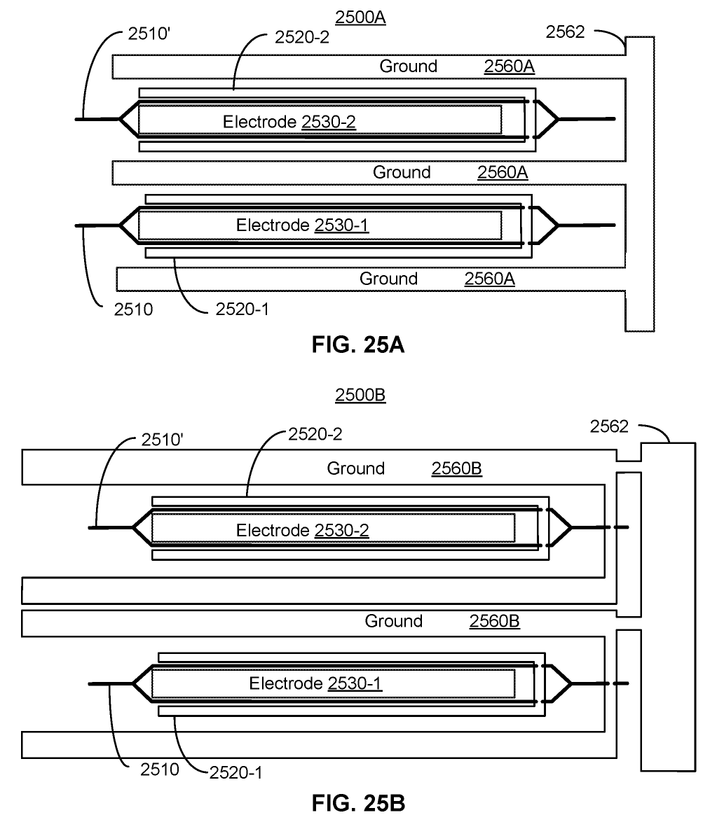

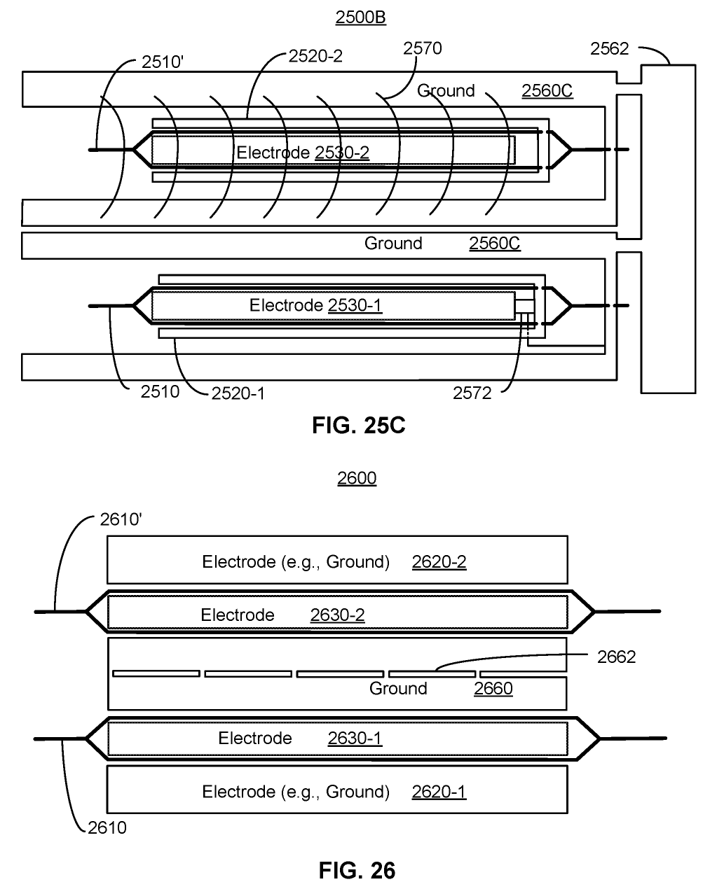

FIGS. 25A-25C depict plan views of embodiments of portions of compact TFLC optical devices 2500A, 2500B and 2500C usable in applications such as data communication. TFLC optical devices 2500A, 2500B and/or 2500C may be or be part of a TFLC PIC such as TFLC PIC 100. Thus, TFLC optical devices 2500A, 2500B and/or 2500C are described as TFLC PIC(s) 2500A, 2500B and/or 2500C. TFLC PIC(s) 2500A, 2500B and/or 2500C are also in the form of optical modulators analogous to optical modulator 105. In some embodiments, TFLC PIC(s) 2500A, 2500B and/or 2500C may have other and/or additional functions. Thus, multiple modulators, each of which corresponds to the portion of 2500A, 2500B and/or 2500C shown, may be present. In some embodiments, two adjacent channels may be configured to carry counter-propagating signals.

Referring to FIG. 25A, TFLC PIC 2500A includes waveguides 2510 and 2510’ (collectively or generically waveguides 2510) that may be used for two modulators. TFLC PIC 2500A also includes electrodes 2530-1 and 2530-2 (collectively or generically electrode(s) 2530) that are analogous to waveguides 1610 and electrode 1630. Additional electrodes (not shown) that carry electrode signals may be used. Although shown as having a simple (rectangular) footprint, electrode 2530 may have another structure. For example, electrode 2530 might include a channel region, extensions, and/or apertures. TFLC PIC 2500 also includes grounds 2560A that are placed between modulators (e.g., waveguides 2510 and 2510’) tied to common ground bus 2562. Optionally, ground bus 2562 may be connector to an off-chip ground via one or more contact points. Ground electrodes 2560A may be narrow (e.g. less than 10 micrometers or less than eight micrometers, and at least one micrometer wide). For example, the grounds may be nominally five micrometers wide.

Referring to FIG. 25B, TFLC PIC 2500B is analogous to TFLC PIC 2500A. TFLC PIC 2500B includes waveguides 2510 and 2510’ and electrodes 2530-1 and 2530-2 (generically or collectively 2530) that are analogous to waveguides 2510 and electrodes 2530 of TFLC PIC 2500A. TFLC PIC 2500B also includes grounds 2560B, which form a shell around each waveguide 2510 and 2510’ (and thus the corresponding optical modulators). These dedicated ground shells 2560B may each coupled to ground bus 2562.

Referring to FIG. 25C, TFLC PIC 2500C is analogous to TFLC PIC(s) 2500A and/or 2500B. Thus, TFLC PIC 2500C includes waveguides 2510 and 2510’, electrodes 2530-1 and 2530-2, ground shells 2560, and ground bus 2562. In addition, wirebonds 2570 may be used. Wirebonds 2570 may improve the ground path of each grounding shell 2560C. Although only one modulator is indicated as having wirebonds, another number (e.g., some or all) may utilize wire bonds. In addition, the modulator(s) may include termination resistors 2672 for electrodes 2530. Although only one termination resistor 2572 for electrode 2530-1 is present, multiple may be used.

Because the shielding is improved for each modulator/waveguide 2510, crosstalk may be reduced. Thus, the optical modulators of TFLC PIC(s) 2500A, 2500B and/or 2500C may have a smaller width than an optical modulator without shielding. The pitch of multiple optical modulators for TFLC 2500A, 2500B and/or 2500C may be reduced. In some embodiments, the pitch for TFLC PICs 2500A, 2500B and/or 2500C may be in the ranges described for optical modulators 105. Thus, the bit rate per modulator, the bit rate per unit width of TFLC PICs 2500A, 2500B and/or 2500C, and/or the bit rate per optical fiber may be increased. Performance of individual optical modulators in TFLC PICs 2500A, 2500B and/or 2500C may also be improved. Particularly when combined with coupling regions which are aligned with the modulation regions, the length of TFLC PICs 2500A, 2500B and/or 2500C may also be reduced. Thus, higher density integration may be possible.

FIG. 26 depicts a plan view of an embodiment of portions of compact TFLC optical device 2600 usable in applications such as data communication. TFLC optical device 2600 may be or be part of a TFLC PIC such as TFLC PIC 100. Thus, TFLC optical device 2600 is described as a TFLC PIC 2600. TFLC PIC 2600 is also in the form of optical modulators analogous to optical modulator 105. In some embodiments, TFLC PIC 2600 may have other and/or additional functions. Thus, multiple modulators, each of which corresponds to the portion of PIC 2600 shown, may be present. In some embodiments, two adjacent channels may be configured to carry counter-propagating signals.

TFLC PIC 2600 is analogous to TFLC PICs 2500A, 2500B, and/or 2500C. TFLC PIC 2600 includes waveguides 2610 and 2610’ (collectively or generically waveguides 2610) and electrodes 2630-1 and 2630-2 (collectively or generically electrodes 2630) that are analogous to waveguides 2510 and 2510’ and electrodes 2530-1 and 2530-2. Also shown are grounds 2620-1, 2620-2, and 2560 that are analogous to grounds 2560A, 2560B, and/or 2560C. In some embodiments, grounds 2560, 2520-1 and 2620-2. Although not shown, grounds 2620-1, 2620-2, and 2660 may be connected to a ground bus. In addition, ground line 2660 includes apertures 2662. Apertures 2662 may suppress current flow induced crosstalk while periodic wire connections (e.g. wirebonds 2570) suppress slot-line mode excitations.

TFLC PIC 2600 shares the benefits of TFLC PIC(s) 2500A, 2500B, and/or 2500C. Because the shielding is improved for each modulator/waveguide(s) 2610, crosstalk may be reduced. Thus, the optical modulators of TFLC PIC(s) 2600 may have a smaller width than an optical modulator without shielding. The pitch of multiple optical modulators for TFLC 2600 may be reduced. In some embodiments, the pitch for TFLC PIC 2600 may be in the ranges described for optical modulators 105. Thus, the bit rate per modulator, the bit rate per unit width of TFLC PIC 2600, and/or the bit rate per optical fiber may be increased. Performance of individual optical modulators in TFLC PIC 2600A may also be improved. Particularly when combined with coupling regions which are aligned with the modulation regions, the length of TFLC PIC 2600A may also be reduced. Thus, higher density integration may be possible.

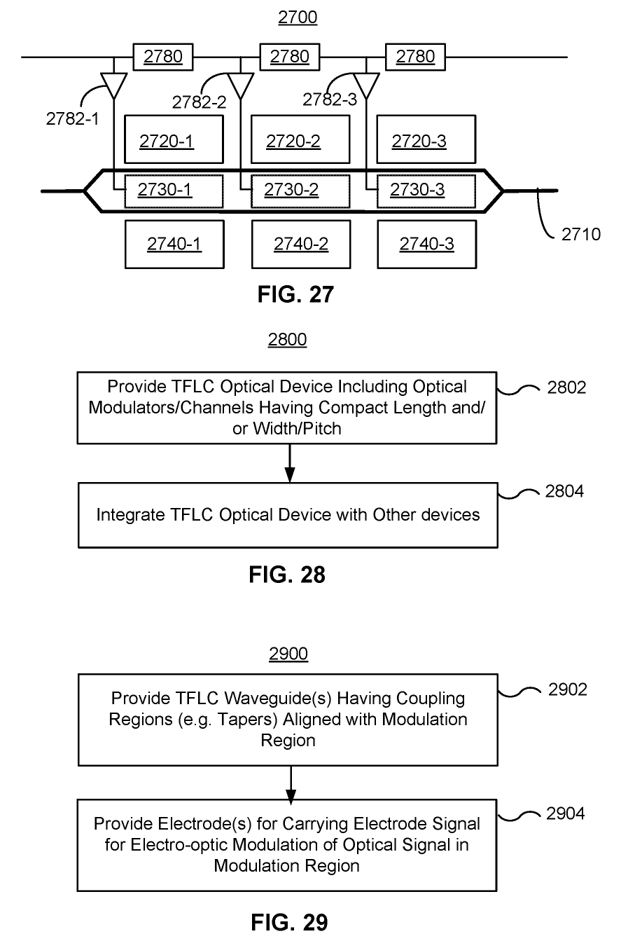

FIG. 27 depicts diagram of an embodiment of portions of compact TFLC optical device 2700 usable in applications such as data communication. TFLC optical device 2700 may be or be part of a TFLC PIC such as TFLC PIC 100. Thus, TFLC optical device 2700 is described as a TFLC PIC 2700. TFLC PIC 2700 is also in the form of optical modulators analogous to optical modulator 105. In some embodiments, TFLC PIC 2700 may have other and/or additional functions. Thus, multiple modulators, each of which corresponds to the portion of PIC 2700 shown, may be present. In some embodiments, two adjacent channels may be configured to carry counter-propagating signals.

TFLC PIC 2700 is a lumped element device. Thus, electrodes 2720, 2730, andn2740 are broken into sections (2720-1, 2730-1 and 2740-1; 2720-2, 2730-2 and 2740-2; and 2720-3, 2730-3 and 2740-3). Each section is separately driven using drivers 2782-1, 2782-2, and 2782-3. Delays 2780 may be used to match the speed of the electrical signal with that of the optical signal in waveguide 2710. Because sections 1, 2, and 3 of TFLC PIC 2600 are so short, crosstalk between the modulator shown and other modulators may be reduced.

TFLC PIC 2700 shares the benefits of TFLC PIC(s) 2500A, 2500B, and/or 2500C. Because of the lumped element configuration of TFLC PIC 2700, crosstalk may be reduced. Thus, the optical modulators of TFLC PIC(s) 2700 may have a smaller width than an optical modulator without shielding. The pitch of multiple optical modulators for TFLC 2700 may be reduced. In some embodiments, the pitch for TFLC PIC 2700 may be in the ranges described for optical modulators 105. Thus, the bit rate per modulator, the bit rate per unit width of TFLC PIC 2700, and/or the bit rate per optical fiber may be increased. Performance of individual optical modulators in TFLC PIC 2700 may also be improved. Particularly when combined with coupling regions which are aligned with the modulation regions, the length of TFLC PIC 2700A may also be reduced. Thus, using combinations of features described herein, high density integration of TFLC PICs may be accomplished.

FIG. 28 is a flow chart depicting an embodiment of method 2800 for providing a compact TFLC PIC optical device usable in applications such as data communication. Method 2800 is described in the context of processes that may have sub-processes. Although described in a particular order, another order not inconsistent with the description herein may be utilized. Method 2800 is also described in the context of TFLC PIC 100. However, method 2800 may be used with other devices.

A TFLC optical device having the desired characteristics is provided, at 2802. For example, a sufficiently high bit rate per unit length or fiber, a sufficiently low V-pi and/or Vi-pi-L, the desired optical losses, and other features are provided. The TFLC optical device is integrated with other components, at 2804. For example, the TFLC PIC may be integrated with another PIC, with drivers and/or other electronic circuits, processing unit(s), and/or other ICs.

For example, at 2802, TFLC PIC 100 may be formed. This may include providing optical modulators 105 and other optical components of electro-optics 104. In addition, optical interface 102 and electrical interface 106 may also be fabricated. At 2804, TFLC PIC is integrated with other devices. For example, another PIC (e.g., PIC 301) and/or another IC may be combined with TFLC PIC 100. Thus, the desired characteristics of the optical components may be provided.

FIG. 29 is a flow chart depicting an embodiment of a method for providing a compact thin film lithium-containing optical device usable in applications such as data communication. Method 2900 is described in the context of processes that may have sub-processes. Although described in a particular order, another order not inconsistent with the description herein may be utilized. Method 2900 is also described in the context of TFLC PIC 300. However, method 2900 may be used with other devices.

TFLC waveguide(s) are fabricated, at 2902. The waveguides include portions that will be used to optically couple to other waveguides as well as portions at which the optical signal carried in the waveguides is modulated. For example, straight portions, bends, and tapers may be fabricated at the appropriate locations on the TFLC PIC. These portions of the TFLC waveguides may be fabricated using one or more etches of a TFLC layer. Thus, in 2902, coupling regions (e.g. optical interfaces), modulation regions, and other portions of the waveguide are formed.

Electrode(s) used to carry the electrode signals for electro-optically modulating the optical signal are provided, at 2902. In some embodiments, 2904 occurs after not only 2902 but also providing cladding and/or other components of the TFLC PIC. In some embodiments, some or all of 2904 may be performed after the TFLC PIC is prepared for flip-chip bonding. The electrodes provided at 2904 are proximate to the waveguide(s) in the modulation region(s). In addition, the electrical interface may be provided as part of 2904. For example, electrical inputs to and outputs from the TFLC PIC, including input and outputs for the electrode(s) are provided. Thus, the TFLC PIC may be fabricated.

For example, waveguides 310-1 and 310-2 may be fabricated at 2902. This includes forming portions 311 and 313 of coupling regions 347 as well as portions 315 for modulation region 349. In some embodiment, 2902 includes tapering portions 311 and 313 of waveguides 310. At 2904, electrodes 320, 330, and 340 are formed. Thus, electrodes 320, 330, and 340 may be configured to have a gap proximate to portions 315 of waveguides 310 in the modulation region. Further, 2902 and 2904 are provided such that the coupling region 347 is at least partially aligned with the modulation region 349. Thus, a TFLC PIC, such as TFLC PIC 300, may be provided and benefits described herein achieved.

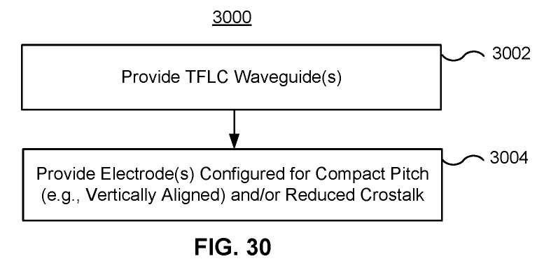

FIG. 30 is a flow chart depicting an embodiment of method 3000 for providing a compact thin film lithium-containing optical device usable in applications such as data communication. Method 3000 is described in the context of processes that may have sub-processes. Although described in a particular order, another order not inconsistent with the description herein may be utilized. Method 3000 is also described in the context of TFLC PIC 1600A. However, method 3000 may be used with other devices.

TFLC waveguide(s) are fabricated, at 3002. The waveguides have the desired components (e.g., splitters, tapers, etc.) and performance characteristics for the TFLC PICs being formed.

Electrode(s) used to carry the electrode signals for electro-optically modulating the optical signal and which are configured for a compact pitch are provided, at 3002. In some embodiments, 3004 occurs after not only 3002 but also providing cladding and/or other components of the TFLC PIC. In some embodiments, some or all of 3004 may be performed after the TFLC PIC is prepared for flip-chip bonding. The electrodes provided at 3004 are not only proximate to the waveguide(s) in the modulation region(s), but may also be vertically aligned and/or offset. Further, as part of 3004, extended portions and/or extensions may be provided. Ground(s) and/or shielding may also be provided at 3004. In addition, the electrical interface may be provided as part of 3004. For example, electrical inputs to and outputs from the TFLC PIC, including input and outputs for the electrode(s) are provided. Thus, the TFLC PIC may be fabricated.

For example, waveguides 1610-1 and 1610-2 may be fabricated at 3002. In some embodiments, this step includes forming coupling regions analogous to coupling regions 347 as well as remaining portions of waveguides 1610.

At 3004, electrodes 1620 and 1630 are formed. A simple electrode 1620 may be formed. In addition, electrode 1630 with extended portions 1634 and channel 16342 that is vertically offset from but at least partially aligned with electrode 1620 is provided. Thus, a TFLC PIC, such as TFLC PIC 1600A, may be provided and benefits described herein achieved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An electro-optic device, comprising:
a plurality of optical modulators corresponding to a plurality of channels, each of the plurality of optical modulators including at least one thin film lithium-containing (TFLC) material, the plurality of optical modulators having a pitch of not more than two hundred micrometers.

2. The electro-optic device of claim 1, wherein each of the plurality of optical modulators further includes:
a waveguide including the at least one TFLC material and configured to carry an optical signal; and
a plurality of electrodes, the plurality of electrodes configured to carry an electrode signal for modulating the optical signal, a portion of the waveguide being between a first portion of a first electrode of the plurality of electrodes and a first portion of a second electrode of the plurality of electrodes, a second portion of the first electrode and a second portion of the second electrode being offset in a direction perpendicular-to-plane for the electro-optic device.

3. The electro-optic device of claim 2, wherein the second portion of the first electrode and the second portion of the second electrode are offset in another direction in-plane for the electro-optic device.

4. The electro-optic device of claim 2, further comprising:
shielding between the plurality of optical modulators.

5. The electro-optic device of claim 2, wherein the plurality of electrodes include a plurality of extensions and a channel region, the extensions extending from the channel region.

6. The electro-optic device of claim 5, wherein a first portion of the plurality of extensions extends above the waveguide and a second portion of the plurality of extensions extends below the waveguide.

7. The electro-optic device of claim 5, wherein the channel region includes at least one aperture therein.

8. The electro-optic device of claim 1, wherein an optical modulator of the plurality of optical modulators includes lumped elements.

9. The electro-optic device of claim 1, wherein at least two adjacent channels of the plurality of channels are configured to carry counter-propagating signals.

10. The electro-optic device of claim 1, wherein the pitch is not more than one hundred and thirty micrometers.

11. The electro-optic device of claim 1, wherein each of the plurality of optical modulators has at least one of an electro-optic bandwidth of at least 120 GHz, a crosstalk with another of the plurality of optical modulators of less than thirty dB, a Vpi of at least 5 V, an optical loss of not more than 1 dB through a modulator of the plurality of optical modulators, and a length of at least 0.5 millimeter and not more than five millimeters.

12. The electro-optic device of claim 1, wherein the electro-optic device is a TFLC photonic integrated circuit.

13. The electro-optic device of claim 1, wherein each of the plurality of optical modulators further includes:
at least one electrode, a portion of each of the least one electrode residing in a modulation region and carrying an electrode signal; and
a waveguide including the at least one TFLC material, the waveguide including a first portion, a second portion, and a third portion, the first portion being optically coupled with a first waveguide, the second portion being optically coupled with a second waveguide, the third portion being in the modulation region, an optical signal in the third portion being modulated by an electric field generated by the electrode signal;
wherein at least a part of at least one of the first portion and the second portion is aligned with the modulation region.

14. The electro-optic device of claim 13, wherein the electro-optic device is configured to support optical signals corresponding to at least one of first transmission of at least 700 Gb/s per millimeter of width of the electro-optic device or second transmission of at least 800 Gb/s per optical fiber.

15. The electro-optic device of claim 13, wherein the first waveguide and the second waveguide reside on a photonics device coupled with the electro-optic device; and
wherein at least one of the electro-optic device and the photonics device includes an interface configured to be coupled with an additional IC.

16. An electro-optic device, comprising:
a waveguide including at least one thin film lithium-containing (TFLC) material and configured to carry an optical signal; and
a plurality of electrodes, the plurality of electrodes configured to carry an electrode signal for modulating the optical signal, a portion of the waveguide being between a first portion of a first electrode of the plurality of electrodes and a first portion of a second electrode of the plurality of electrodes, a second portion of the first electrode and a second portion of the second electrode being offset in a direction perpendicular-to-plane for the electro-optic device.

17. A method, comprising:
providing a plurality of optical modulators of an electro-optic device, the plurality of optical modulators corresponding to a plurality of channels, each of the plurality of optical modulators including at least one thin film lithium-containing (TFLC) material, the plurality of optical modulators having a pitch of not more than two hundred micrometers.

18. The method of claim 17, wherein providing the plurality of optical modulators further includes, for each of the plurality of optical modulators:
providing a waveguide including the at least one TFLC material and configured to carry an optical signal; and
providing a plurality of electrodes, the plurality of electrodes configured to carry an electrode signal for modulating the optical signal, a portion of the waveguide being between a first portion of a first electrode of the plurality of electrodes and a first portion of a second electrode of the plurality of electrodes, a second portion of the first electrode and a second portion of the second electrode being offset in a direction perpendicular-to-plane for the electro-optic device.

19. The method of claim 18, wherein a third portion of each of the plurality of electrodes resides in a modulation region; and
wherein providing the waveguide further includes providing a first portion, a second portion, and a third portion of the waveguide, the first portion of the waveguide being optically coupled with a first waveguide, the second portion of the waveguide being optically coupled with a second waveguide, the third portion of the waveguide being in the modulation region, the optical signal in the third portion of the waveguide being modulated by an electric field generated by the electrode signal;
wherein at least a part of at least one of the first portion of the waveguide and the second portion of the waveguide is aligned with the modulation region.

20. The method of claim 18, wherein providing the plurality of electrodes further includes:
providing a plurality of extensions and a channel region, the extensions extending from the channel region.

21. The method of claim 20, wherein at least one of the channel region includes at least one aperture therein or a first portion of the plurality of extensions extends above the waveguide and a second portion of the plurality of extensions extends below the waveguide.
